(19) United States
(12) Patent Application Publication
(10) Pub. No.: US 2024/0178985 A1
(43) Pub. Date: May 30, 2024

(54) PER SYMBOL/SLOT-TYPE BEAM CONFIGURATION

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US); Tao LUO, San Diego, CA (US)

(21) Appl. No.: 18/514,685

(22) Filed: Nov. 20, 2023

Related U.S. Application Data
(60) Provisional application No. 63/385,573, filed on Nov. 30, 2022.

(51) Int. Cl. H04L 5/14; H04W 72/044

(52) U.S. Cl. CPC H04L 5/14; H04W 72/044

(57) ABSTRACT

Various aspects of the present disclosure generally relate to wireless communication. In some aspects, a network node (NN) may perform a communication, of a downlink (DL) communication or an uplink (UL) communication, during a first slot or symbol. The NN may perform the communication during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with sub-band full duplex (SBFD) communication or dynamic time division duplex (TDD) communication. Numerous other aspects are described.

### CROSS-REFERENCE TO RELATED APPLICATION

This Patent Application claims priority to U.S. Provisional Patent Application No. 63/385,573, filed on Nov. 30, 2022, entitled “PER SYMBOL/SLOT-TYPE BEAM CONFIGURATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for per-symbol/slot-type beam configurations.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node (NN). The method may include performing a communication, of a downlink (DL) communication or an uplink (UL) communication, during a first slot or symbol. The method may include performing the communication during a second slot or symbol in addition to during the first slot or symbol, where a communication parameter of the communication during the first slot or symbol is different from a communication parameter of the communication during the second slot or symbol based at least in part on the first slot or symbol and the second slot or symbol being associated with sub-band full duplex (SBFD) communication or dynamic time division duplex (TDD) communication.

Some aspects described herein relate to a method of wireless communication performed by a UE. The method may include receiving a DL communication or transmitting a UL communication, wherein the DL communication or the UL communication is during a first slot or symbol. The method may include performing a communication, of the DL communication or the UL communication, during a second slot or symbol in addition to during the first slot or symbol, where a communication parameter of the communication during the first slot or symbol is different from a communication parameter of the communication during the second slot or symbol based at least in part on the first slot or symbol and the second slot or symbol being associated with SBFD communication or dynamic TDD communication.

Aspects generally include a method, apparatus, system, computer program product, non-transitory computer-readable medium, user equipment, base station, network entity, network node, wireless communication device, and/or processing system as substantially described herein with reference to and as illustrated by the drawings, specification, and appendix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating examples of full-duplex communication in a wireless network, in accordance with the present disclosure.

FIG. 5 is a diagram illustrating an example of SBFD activation, in accordance with the present disclosure.

FIG. 6 is a diagram illustrating an example of using beams for communications between a network node and a UE, in accordance with the present disclosure.

FIG. 7 is a diagram illustrating an example associated with full duplex communications with per-symbol/slot-type beam configurations, in accordance with the present disclosure.

FIG. 8 is a diagram of an example associated with per slot/symbol beam configurations, in accordance with the present disclosure.

FIG. 9 is a diagram illustrating an example process performed, for example, by a network node, in accordance with the present disclosure.

FIG. 10 is a diagram illustrating an example process performed, for example, by a UE, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

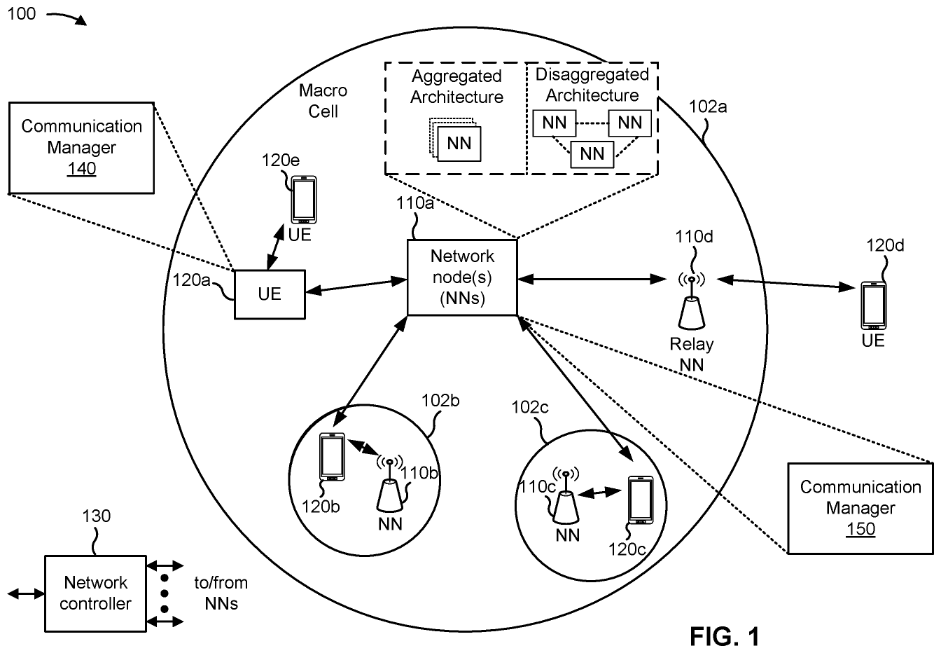

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station (BS)), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the network node 110 may include a communication manager 150. As described in more detail elsewhere herein, the communication manager 150 may output a downlink (DL) communication; receive an uplink (UL) communication, wherein the DL communication and the UL communication are during a first slot; and perform a communication, of the DL communication or the UL communication, during a second slot in addition to during the first slot, wherein a communication parameter of the communication during the first slot is different from a communication parameter of the communication during the second slot. Additionally, or alternatively, the communication manager 150 may perform one or more other operations described herein.

In some aspects, the UE 120 may include a communication manager 140. As described in more detail elsewhere herein, the communication manager 140 may receive a DL communication; transmit a UL communication, wherein the DL communication and the UL communication are during a first slot; and perform a communication, of the DL communication or the UL communication, during a second slot in addition to during the first slot, wherein a communication parameter of the communication during the first slot is different from a communication parameter of the communication during the second slot. Additionally, or alternatively, the communication manager 140 may perform one or more other operations described herein.

As indicated above, FIG. 1 is provided as an example. Other examples may differ from what is described with regard to FIG. 1.

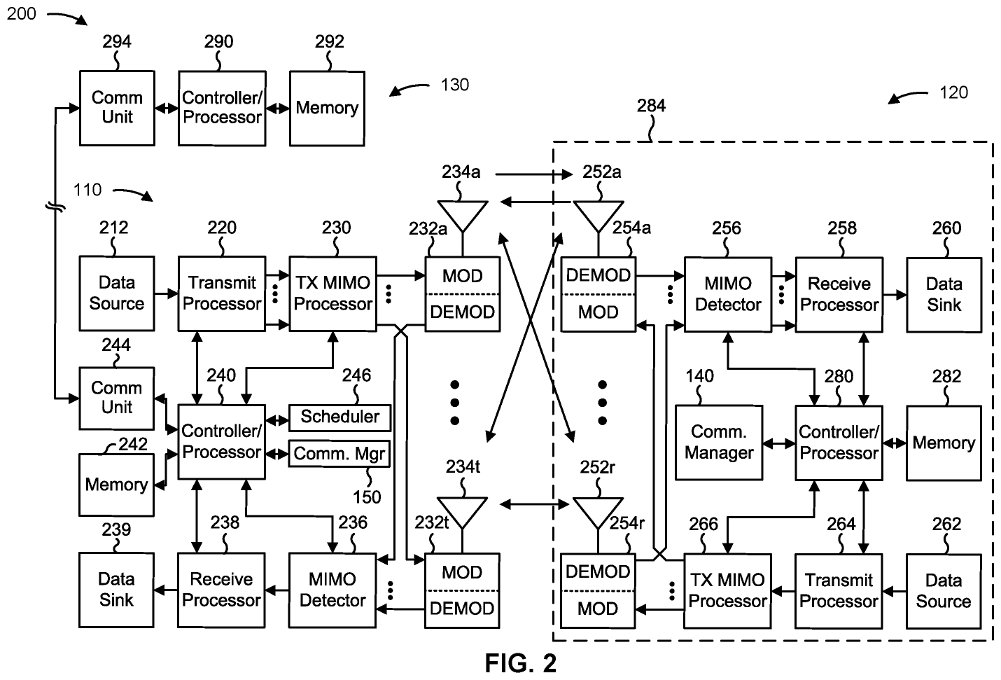

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

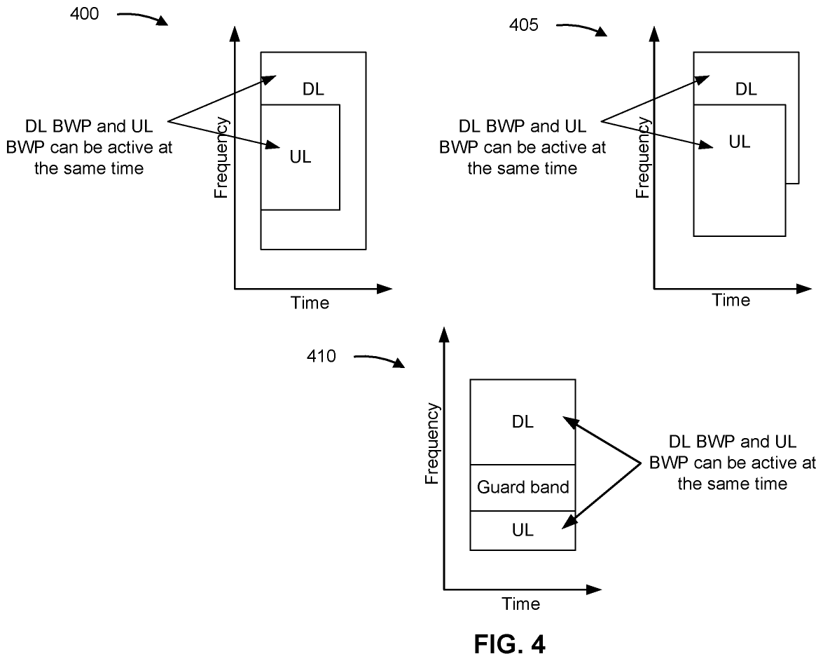

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

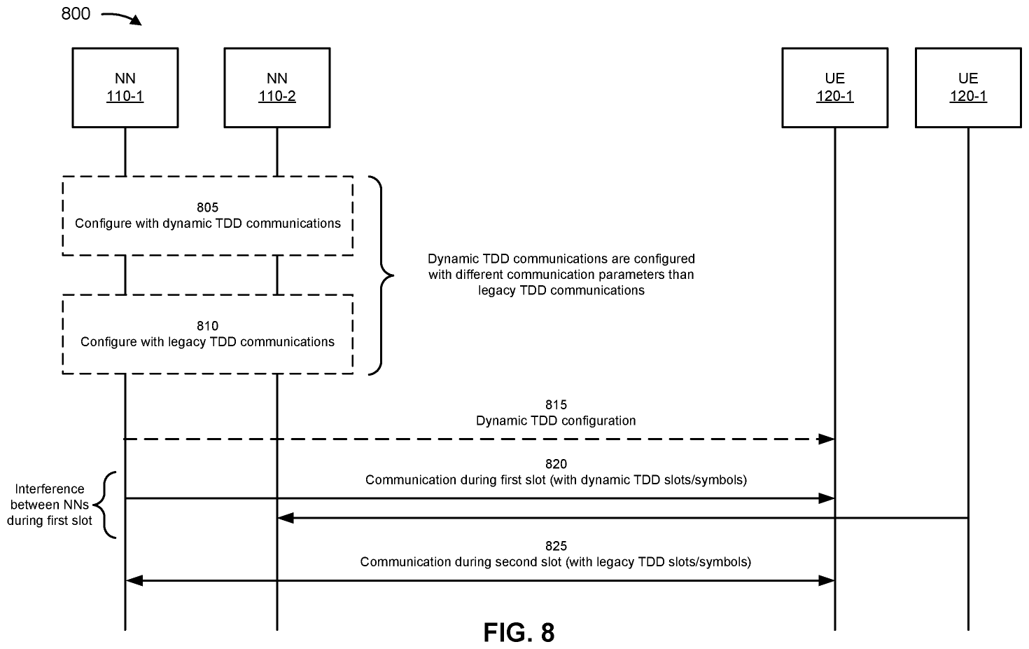

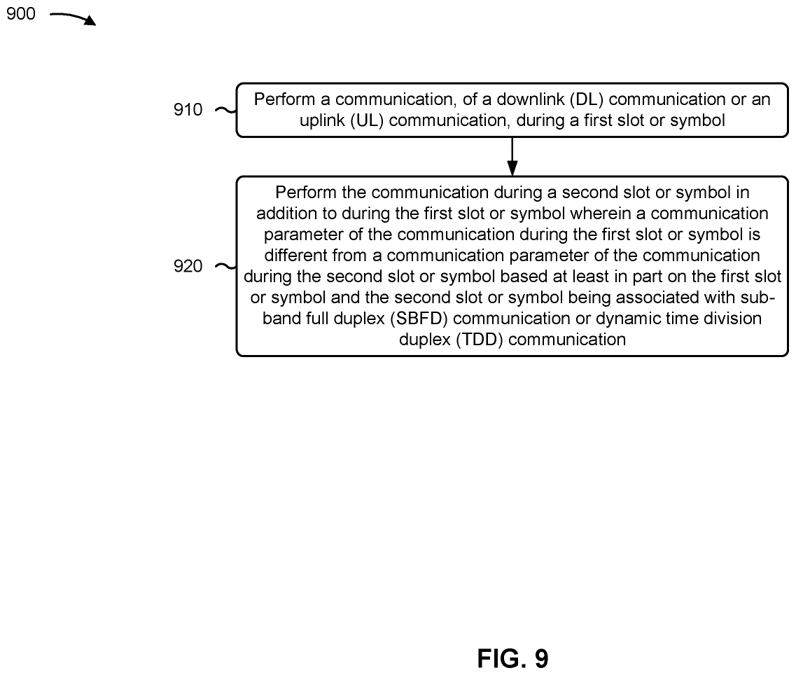

The controller/processor 240 of the network node 110, the controller/processor 280 of the UE 120, and/or any other component(s) of FIG. 2 may perform one or more techniques associated with full duplex (FD) communications with per-symbol/slot-type beam configurations, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a network node (e.g., the network node 110) includes means for outputting a DL communication; means for receiving a UL communication, wherein the DL communication and the UL communication are during a first slot; and/or means for performing a communication, of the DL communication or the UL communication, during a second slot in addition to during the first slot, wherein a communication parameter of the communication during the first slot is different from a communication parameter of the communication during the second slot. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a UE (e.g., the UE 120) includes means for receiving a DL communication; means for transmitting a UL communication, wherein the DL communication and the UL communication are during a first slot; and/or means for performing a communication, of the DL communication or the UL communication, during a second slot in addition to during the first slot, wherein a communication parameter of the communication during the first slot is different from a communication parameter of the communication during the second slot. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

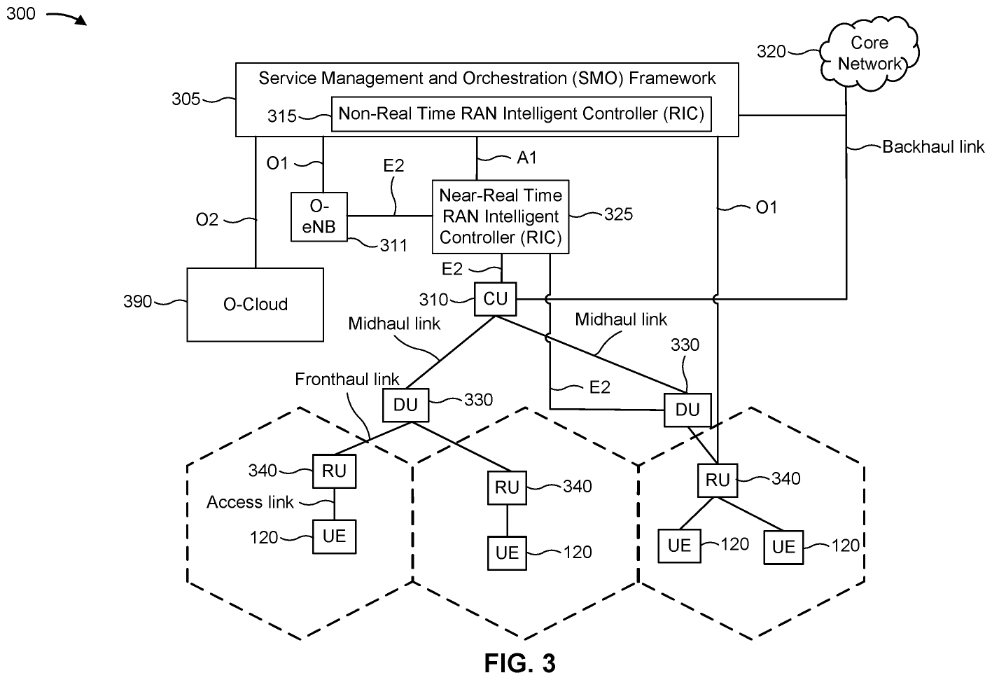

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-CNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating examples 400, 405, and 410 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 4, examples 400 and 405 show examples of in-band full-duplex (IBFD) communication. In IBFD, a UE may transmit an uplink communication to a base station and receive a downlink communication from the base station on the same time and frequency resources. As shown in example 400, in a first example of IBFD, the time and frequency resources for uplink communication may fully overlap with the time and frequency resources for downlink communication. As shown in example 405, in a second example of IBFD, the time and frequency resources for uplink communication may partially overlap with the time and frequency resources for downlink communication.

As further shown in FIG. 4, example 410 shows an example of sub-band full-duplex (SBFD) communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 4 is provided as an example. Other examples may differ from what is described with respect to FIG. 4.

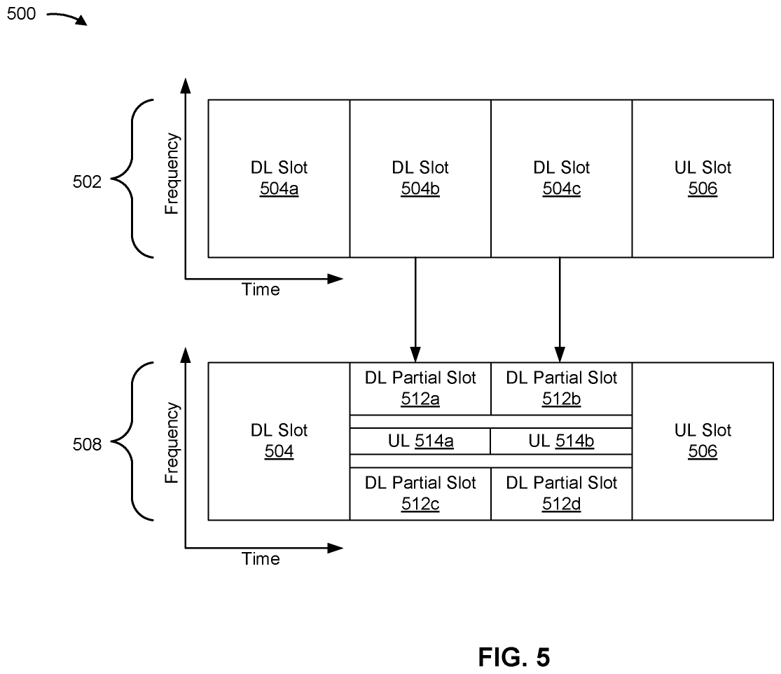

FIG. 5 is a diagram illustrating an example 500 of SBFD activation, in accordance with the present disclosure. As shown in FIG. 5, example 500 includes a first configuration 502. In some aspects, the first configuration 502 may indicate a first slot format pattern (sometimes called a TDD pattern) associated with a half-duplex mode or a full-duplex mode. The first slot format pattern may include a quantity of downlink slots 504 (e.g., three downlink slots 504a, 504b, and 504c, as shown), a quantity of flexible slots (not shown), and/or a quantity of uplink slots (e.g., one uplink slot 506, as shown). The first slot format pattern may repeat over time. In some aspects, a network node 110 may indicate the first slot format pattern to a UE 120 using one or more slot format indicators. A slot format indicator, for a slot, may indicate whether that slot is an uplink slot, a downlink slot, or a flexible slot, among other examples.

A network node 110 may instruct (e.g., using an indication, such as a radio resource control (RRC) message, a medium access control (MAC) control element (CE) (MAC-CE), or downlink control information (DCI)) a UE 120 to switch from the first configuration 502 to a second configuration 508. As an alternative, the UE 120 may indicate to the network node 110 that the UE 120 is switching from the first configuration 502 to the second configuration 508. The second configuration 508 may indicate a second slot format pattern that repeats over time, similar to the first slot format pattern. In any of the aspects described above, the UE 120 may switch from the first configuration 502 to the second configuration 508 during a time period (e.g., a quantity of symbols and/or an amount of time (e.g., in milliseconds (ms)) based at least in part on an indication received from the network node 110 (e.g., before switching back to the first configuration 502). During that time period, the UE 120 may communicate using the second slot format pattern, and then may revert to using the first slot format pattern after the end of the time period. The time period may be indicated by the network node 110 (e.g., in the instruction to switch from the first configuration 502 to the second configuration 508, as described above) and/or based at least in part on a programmed and/or otherwise preconfigured rule. For example, the rule may be based at least in part on a table (e.g., defined in 3GPP specifications and/or another wireless communication standard) that associates different sub-carrier spacings (SCSs) and/or numerologies (e.g., represented by u and associated with corresponding SCSs) with corresponding time periods for switching configurations.

In example 500, the second slot format pattern includes two SBFD slots in place of what were downlink slots in the first slot format pattern. In example 500, each SBFD slot includes a partial slot (e.g., a portion or sub-band of a frequency allocated for use by the network node 110 and the UE 120) for downlink (e.g., partial slots 512a, 512b, 512c, and 512d, as shown) and a partial slot for uplink (e.g., partial slots 514a and 514b, as shown). Accordingly, the UE 120 may operate using the second slot format pattern to transmit an uplink communication in an earlier slot (e.g., the second slot in sequence, shown as partial UL slot 514a) as compared to using the first slot format pattern (e.g., the fourth slot in sequence, shown as UL slot 506). Other examples may include additional or alternative changes. For example, the second configuration 508 may indicate an SBFD slot in place of what was an uplink slot in the first configuration 502 (e.g., UL slot 506). In another example, the second configuration 508 may indicate a downlink slot or an uplink slot in place of what was an SBFD slot in the first configuration 502 (not shown in FIG. 5). In yet another example, the second configuration 508 may indicate a downlink slot or an uplink slot in place of what was an uplink slot or a downlink slot, respectively, in the first configuration 502. “SBFD slot” may refer to a slot in which an SBFD format is used. An SBFD format may include a slot format in which full duplex communication is supported (e.g., for both uplink and downlink communications), with one or more frequencies used for an uplink portion of the slot being separated from one or more frequencies used for a downlink portion of the slot by a guard band. In some aspects, the SBFD format may include a single uplink portion and a single downlink portion separated by a guard band. In some aspects, the SBFD format may include multiple downlink portions and a single uplink portion that is separated from the multiple downlink portions by respective guard bands (e.g., as shown in FIG. 5). In some aspects, an SBFD format may include multiple uplink portions and a single downlink portion that is separated from the multiple uplink portions by respective guard bands. In some aspects, the SBFD format may include multiple uplink portions and multiple downlink portions, where each uplink portion is separated from a downlink portion by a guard band. In some aspects, operating using an SBFD mode may include activating or using an FD mode in one or more slots based at least in part on the one or more slots having the SBFD format. A slot may support the SBFD mode if a UL bandwidth part (BWP) and a DL BWP are permitted to be or are simultaneously active in the slot in an SBFD fashion (e.g., with guard band separation).

By switching from the first configuration 502 to the second configuration 508, the network node 110 and the UE 120 may experience increased quality and/or reliability of communications. For example, the network node 110 and the UE 120 may experience increased throughput (e.g., using a full-duplex mode), reduced latency (e.g., the UE 120 may be able to transmit an uplink and/or a downlink communication sooner using the second configuration 508 rather than the first configuration 502), and increased network resource utilization (e.g., by using both the DL BWP and the UL BWP simultaneously instead of only the DL BWP or the UL BWP).

As indicated above, FIG. 5 is provided as an example. Other examples may differ from what is described with respect to FIG. 5.

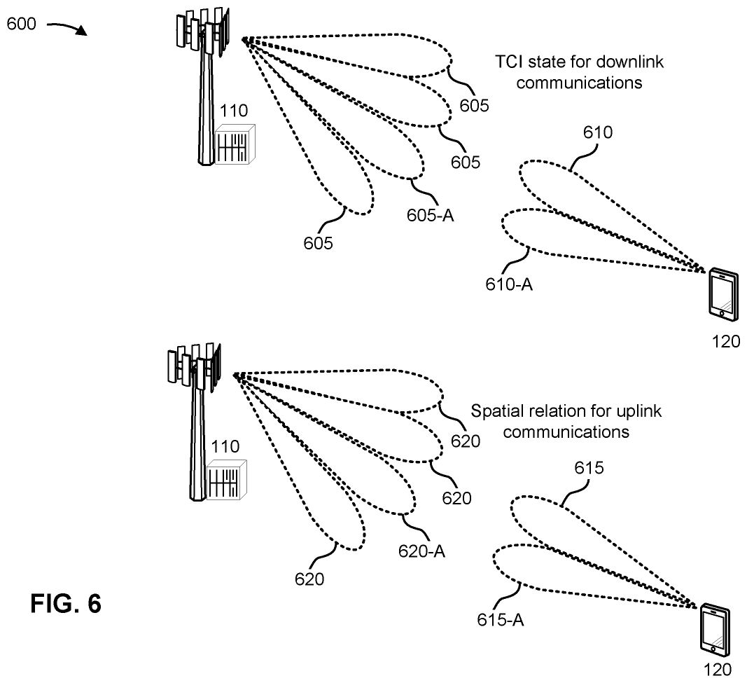

FIG. 6 is a diagram illustrating an example 600 of using beams for communications between a network node and a UE, in accordance with the present disclosure. As shown in FIG. 6, a network node 110 and a UE 120 may communicate with one another.

The network node 110 may transmit to UEs 120 located within a coverage area of the network node 110. The network node 110 and the UE 120 may be configured for beamformed communications, where the network node 110 may transmit in the direction of the UE 120 using a directional network node (NN) transmit beam (e.g., a BS transmit beam), and the UE 120 may receive the transmission using a directional UE receive beam. Each NN transmit beam may have an associated beam ID, beam direction, or beam symbols, among other examples. The network node 110 may transmit downlink communications via one or more NN transmit beams 605.

The UE 120 may attempt to receive downlink transmissions via one or more UE receive beams 610, which may be configured using different beamforming parameters at receive circuitry of the UE 120. The UE 120 may identify a particular NN transmit beam 605, shown as NN transmit beam 605-A, and a particular UE receive beam 610, shown as UE receive beam 610-A, that provide relatively favorable performance (for example, that have a best channel quality of the different measured combinations of NN transmit beams 605 and UE receive beams 610). In some examples, the UE 120 may transmit an indication of which NN transmit beam 605 is identified by the UE 120 as a preferred NN transmit beam, which the network node 110 may select for transmissions to the UE 120. The UE 120 may thus attain and maintain a beam pair link (BPL) with the network node 110 for downlink communications (for example, a combination of the NN transmit beam 605-A and the UE receive beam 610-A), which may be further refined and maintained in accordance with one or more established beam refinement procedures.

A downlink beam, such as an NN transmit beam 605 or a UE receive beam 610, may be associated with a transmission configuration indication (TCI) state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each NN transmit beam 605 may be associated with a synchronization signal block (SSB), and the UE 120 may indicate a preferred NN transmit beam 605 by transmitting uplink transmissions in resources of the SSB that are associated with the preferred NN transmit beam 605. A particular SSB may have an associated TCI state (for example, for an antenna port or for beamforming). The network node 110 may, in some examples, indicate a downlink NN transmit beam 605 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 610 at the UE 120. Thus, the UE 120 may select a corresponding UE receive beam 610 from a set of BPLs based at least in part on the network node 110 indicating an NN transmit beam 605 via a TCI indication.

The network node 110 may maintain a set of activated TCI states for downlink shared channel transmissions and a set of activated TCI states for downlink control channel transmissions. The set of activated TCI states for downlink shared channel transmissions may correspond to beams that the network node 110 uses for downlink transmission on a physical downlink shared channel (PDSCH). The set of activated TCI states for downlink control channel communications may correspond to beams that the network node 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the network node 110 using a directional UE transmit beam, and the network node 110 may receive the transmission using a directional NN receive beam. Each UE transmit beam may have an associated beam ID, beam direction, or beam symbols, among other examples. The UE 120 may transmit uplink communications via one or more UE transmit beams 615.

The network node 110 may receive uplink transmissions via one or more NN receive beams 620 (e.g., BS receive beams). The network node 110 may identify a particular UE transmit beam 615, shown as UE transmit beam 615-A, and a particular NN receive beam 620, shown as NN receive beam 620-A, that provide relatively favorable performance (for example, that have a best channel quality of the different measured combinations of UE transmit beams 615 and NN receive beams 620). In some examples, the network node 110 may transmit an indication of which UE transmit beam 615 is identified by the network node 110 as a preferred UE transmit beam, which the network node 110 may select for transmissions from the UE 120. The UE 120 and the network node 110 may thus attain and maintain a BPL for uplink communications (for example, a combination of the UE transmit beam 615-A and the NN receive beam 620-A), which may be further refined and maintained in accordance with one or more established beam refinement procedures. An uplink beam, such as a UE transmit beam 615 or an NN receive beam 620, may be associated with a spatial relation. A spatial relation may indicate a directionality or a characteristic of the uplink beam, similar to one or more QCL properties, as described above.

As indicated above, FIG. 6 is provided as an example. Other examples may differ from what is described with respect to FIG. 6.

Transmitting UL and DL communications within a single slot, which occurs during full duplex communications, can result in self-interference or clutter. Self-interference occurs when signals from a transmitter interfere with signals from a receiver on the same device. For example, the transmitter and receiver of a single network node may interfere with one another during full duplex communications with one or more UEs. Clutter occurs when, for example, signals from the transmitter of the network node are reflected off objects, such as buildings, and received at the receiver of the network node. Self-interference and/or clutter reduces signal quality, increases the number of retransmissions needed to transmit a communication, and negatively impacts network latency.

Some techniques and apparatuses described herein enable a network node to perform a communication, of a DL communication or a UL communication, during a first slot or symbol; and perform the communication during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with SBFD communication or dynamic TDD communication. Accordingly, the network node can reduce interference and clutter by, for example, modifying the configurations for DL communications, UL communications, or both, occurring during multiple slots of differing types. For example, a configuration for a DL communication during a DL-only non-SBFD slot may not be ideal for the DL communication during an SBFD slot. Likewise, a configuration for a UL communication during a UL-only non-SBFD slot may not be ideal for the UL communication during an SBFD slot.

Some techniques and apparatuses described herein enable a UE to receive a DL communication or transmit a UL communication, wherein the DL communication or the UL communication is during a first slot or symbol; and perform a communication, of the DL communication or the UL communication, during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with SBFD communication or dynamic TDD communication. Accordingly, the foregoing approach to SBFD communication can improve communication quality between the UE and, for example, the network node. For example, the foregoing approach to SBFD communication can increase the UL and DL duty cycle, leading to latency reduction and coverage improvement. For instance, with the SBFD techniques described herein, it is possible to transmit UL signals in slots that would otherwise be designated only for DL communications and DL signals in slots that would otherwise be designated only for UL communications while decreasing the risk of self-interference and clutter. Accordingly, the SBFD communication technique described herein can enhance system capacity and resource utilization as well as spectrum efficiency. Moreover, the SBFD communication technique described herein can facilitate flexible and dynamic UL/DL resource adaptation according to UL/DL traffic in a more robust manner.

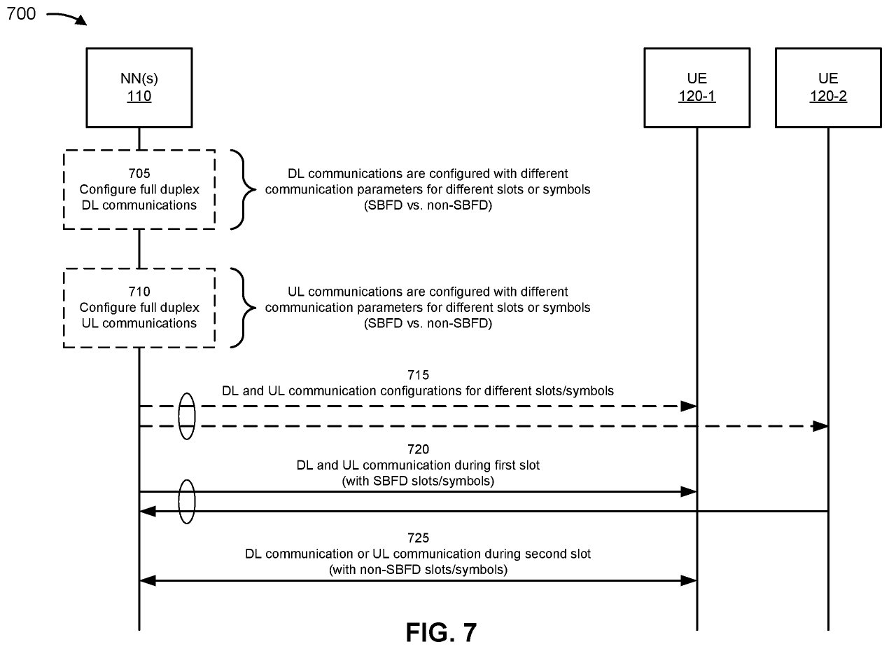

FIG. 7 is a diagram illustrating an example 700 associated with full duplex communications with per-symbol/slot-type beam configurations, in accordance with the present disclosure. As shown in FIG. 7, a network node (such as network node 110) and multiple UEs (such as 120) (shown as UE 120-1 and UE 120-2 in FIG. 7) may communicate with one another. While generally discussed below with reference to slots with SBFD and non-SBFD symbols, the concept may further apply to slots having misaligned cross-dynamic time division duplex (TDD) symbols (e.g., a mix of UL and DL communications resulting from neighboring cells) and aligned legacy symbols (e.g., only UL or DL communications from a cell), as discussed below with reference to FIG. 8.

As shown by reference number 705, the network node 110 may configure a DL communication for SBFD communications, non-SBFD communications, and/or a combination thereof. For example, the network node 110 may configure the DL communication according to a communication parameter such as a TCI state or spatial relation information for communications across slots with SBFD symbols. In some aspects, the DL communication is configured according to a unified TCI framework indicating separate TCI states in the context of unified TCI for the DL communication according to, for example, whether the DL communication is transmitted during an SBFD slot or a non-SBFD slot. In some aspects, the TCI state of the DL communication in the context of unified TCI applied during an SBFD slot or a non-SBFD slot may apply to multiple or unified DL channels and/or reference signals (RS). Examples of spatial relation information may include a QCL type A field, a QCL type B field, a QCL type C field, a QCL type D field, or a QCL type E field. The communication parameter may alternatively include or indicate one or more of indicates at least one of a frequency domain resource allocation (FDRA), a DL transmit power, a UL power control (PC) parameter, a UL maximum transmit power (Pmax), a modulation coding scheme (MCS), a timing advance (TA), a TA offset value, a timing advance group (TAG) index parameter, a frequency hopping pattern, a time and frequency resource configuration, a precoding matrix indicator (PMI), a rank indicator (RI), a bandwidth, a BWP, or a component carrier (CC). In some aspects, rather than providing different communication parameters for SBFD and non-SBFD communications, the network node 110 may configure different communication parameters to address misaligned cross dynamic TDD symbols in the first slot and aligned legacy TDD symbols in the second slot. Configurations associated with the DL communication may be transmitted to the UEs 120 via DCI signaling, RRC signaling, or MAC-CE signaling. Examples of DL communications may include PDSCH communications, PDCCH communications, CSI-RS communications, multi-PDSCH communications, PDCCH/PDSCH repetitions, or the like. In some aspects, the DL communication includes a transport block over multiple slots (TBoMS) across one or more of SBFD symbols or non-SBFD symbols.

In some aspects, the network node 110 may configure different communication parameters, such as TCI states, spatial relation information, a combination thereof, or the like, for different slot types, symbols, or a combination of both. In some aspects, the network node 110 may configure two communication parameters, such as two different TCI states or two different spatial relation information, for DL communications. Based on the configuration, and by assuming that the network node 110 may indicate the time location of SBFD symbols, SBFD-aware UEs 120 may implicitly apply different beam configurations for SBFD and non-SBFD symbols. In some aspects, each of the TCI states may include a different set of QCL type X fields. For example, each of the TCI states may include a different one of QCL type A field, QCL type B field, QCL type C field, QCL type D field, or QCL type E field.

In some aspects, the network node 110 may configure a single communication parameter, such as a single TCI state or single spatial relation information with, for example, two different QCL type X fields. The two different QCL type X fields may correspond to two different DL beams for SBFD and non-SBFD symbols. For example, the TCI state may include two different types of the following: a QCL type A field, a QCL type B field, a QCL type C field, a QCL type D field, or a QCL type E field. In one aspect, the communication parameter is configured to include two different QCL type D fields.

As shown by reference number 710, the network node 110 may configure a UL communication for SBFD communications, non-SBFD communications, and/or a combination thereof. For example, the network node 110 may configure the UL communication according to a communication parameter such as a TCI state or spatial relation information for communications across slots with SBFD symbols. In some aspects, the UL communication is configured according to a unified TCI framework indicating separate TCI states in the context of unified TCI for the UL communication according to, for example, whether the UL communication is transmitted during an SBFD slot or a non-SBFD slot. In some aspects, the TCI state in the context of unified TCI of the UL communication applied during an SBFD slot or a non-SBFD slot may apply to multiple or unified UL channels and/or reference signals (RS). Examples of spatial relation information may include a QCL type A field, a QCL type B field, a QCL type C field, a QCL type D field, or a QCL type E field. The communication parameter may alternatively include or indicate one or more of FDRA, a DL transmit power, a UL PC parameter, an MCS, a TA, a TA offset value, a TAG index parameter, a frequency hopping pattern, a time and frequency resource configuration, a PMI, an RI, a bandwidth, a BWP, or a CC. In some aspects, rather than providing different communication parameters for SBFD and non-SBFD communications, the network node 110 may provide different communication parameters to address misaligned cross dynamic TDD symbols in the first slot and aligned legacy TDD symbols in the second slot. Configurations associated with the UL communication may be transmitted to the UEs 120 via DCI signaling, RRC signaling, or MAC-CE signaling. Examples of UL communications may include physical uplink shared channel (PUSCH) communications, physical uplink control channel (PUCCH) communications, sounding reference signal (SRS) communications, multi-PUSCH communications, PUSCH/PUCCH repetitions, or the like. In some aspects, the UL communication includes a TBoMS across one or more of SBFD symbols or non-SBFD symbols.

In some aspects, the network node 110 may configure different communication parameters, such as TCI states, spatial relation information, a combination thereof, or the like, for different slot types. In some aspects, the network node 110 may configure two communication parameters, such as two different TCI states or two different spatial relation information, for UL communications. Based on the configuration, and by assuming that the network node 110 may indicate the time location of SBFD symbols, SBFD-aware UEs 120 may implicitly apply different beam configurations for SBFD and non-SBFD symbols. In some aspects, each of the TCI states may include a different set of QCL type X fields. For example, each of the TCI states may include a different one of QCL type A field, QCL type B field, QCL type C field, QCL type D field, or QCL type E field.

In some aspects, the network node 110 may configure a single communication parameter, such as a single TCI state or single spatial relation information with, for example, two different QCL type X fields. The two different QCL type X fields may correspond to two different UL beams for SBFD and non-SBFD symbols. For example, the TCI state may include two different types of the following: a QCL type A field, a QCL type B field, a QCL type C field, a QCL type D field, or a QCL type E field. In one aspect, the communication parameter is configured to include two different QCL type D fields.

As shown by reference number 715, the network node 110 may output, and the UEs 120 may receive, configurations for the DL communications, the UL communications, or a combination thereof. The configurations may be transmitted to the UEs 120 via DCI signaling, RRC signaling, MAC-CE signaling, or a combination thereof.

As shown by reference number 720, the network node 110 may output, and the first UE 120-1 may receive, a DL communication during a first slot. Also during the first slot, the second UE 120-2 may transmit, and the network node 110 may receive, a UL communication. The DL communication output by the network node 110 and the UL communication output by the second UE 120-2 may be communicated in accordance with the configurations established as shown by reference numbers 705 and 710. Reference number 720 illustrates an example where the UEs 120 are configured to operate in a half-duplex mode. In some instances, the UE may be configured to operate in a full duplex mode, in which case the DL communication may be received by, and the UL communication may be transmitted from, a single UE (such as the first UE 120-1).

As shown by reference number 725, a communication may occur during a second slot. The communication during the second slot may be a DL communication output by the network node 110 to the first UE 120-1 or a UL communication output by the first UE 120-1 to the network node 110 (as shown). Alternatively, the communication during the second slot may be a DL communication output by the network node 110 to the second UE 120-2 or a UL communication output by the second UE 120-2 to the network node 110. In either instance, the second slot may include non-SBFD symbols, meaning that the communication during the second slot is only a DL communication or a UL communication.

With the foregoing approach, the network node 110 can reduce interference and clutter by, for example, modifying the configurations for DL communications, UL communications, or both, occurring during multiple slots of differing types. For example, a configuration for a DL communication during a DL-only non-SBFD slot may not be ideal for the DL communication during an SBFD slot. Likewise, a configuration for a UL communication during a UL-only non-SBFD slot may not be ideal for the UL communication during an SBFD slot.

Although the terms “first slot” and “second slot” are used with reference to FIG. 7 and elsewhere herein, it is to be appreciated that the communication during the “second slot” may occur before communications during the “first slot”, and vice versa. For example, the communication at reference number 725 may occur prior to the full duplex communication occurring at the first slot indicated by reference number 720.

Moreover, in some aspects, rather than being configured with SBFD and non-SBFD symbols, the first slot and the second slot, respectively, may be configured to address issues arising from misaligned cross dynamic TDD symbols, as discussed below with respect to FIG. 8. For example, the foregoing approach can be applied to instances where one cell is configured for DL communications and a neighboring cell is configured for UL communications. The communication parameters for the DL communications on one cell may be different from the communication parameters for the UL communications on the neighboring cell, which can help reduce interference caused by the neighboring cell.

As indicated above, FIG. 7 is provided as an example. Other examples may differ from what is described with respect to FIG. 7.

FIG. 8 is a diagram of an example 800 associated with per slot/symbol beam configurations, in accordance with the present disclosure. As shown in FIG. 8, multiple network nodes (e.g., network node 110-1, 110-2, etc.) may communicate with one or more UEs (e.g., UE 120-1, 120-2, etc.). The multiple network nodes may include one or more network nodes 110, one or more CUs, one or more DUs, one or more RUs, one or more core network nodes, one or more network servers, one or more application servers, and/or one or more Access and Mobility Management Functions (AMFs), among other examples. In some aspects, the UE and a first network node of the multiple network nodes may be part of a wireless network (e.g., wireless network 100). The UE and the first network node may have established a wireless connection prior to operations shown in FIG. 8.

As shown by reference number 805, the network nodes may be configured according to communication parameters for dynamic TDD communication. The communication parameters for dynamic TDD communication may include a first communication parameter for communications during a first slot or symbol. In some aspects, the network nodes are configured for communication that includes a TBoMS across misaligned dynamic TDD symbols.

As shown by reference number 810, the network nodes may be configured according to communication parameters for legacy TDD communication. The communication parameters for legacy TDD communication may include a second communication parameter for communications during a second slot or symbol. In some aspects, the network nodes are configured for communication that includes a TBoMS across one or more aligned legacy TDD symbols.

As shown by reference number 815, one of the network nodes may transmit, and the UE may receive, configuration information. In some aspects, the UE may receive the configuration information via one or more of RRC signaling, one or more MAC-CE signaling, and/or DCI signaling, among other examples. In some aspects, the configuration information may include an indication of one or more configuration parameters (e.g., already known to the UE and/or previously indicated by the first network node or other network device) for selection by the UE, and/or explicit configuration information for the UE to use to configure the UE, among other examples. The UE may configure itself based at least in part on the configuration information. In some aspects, the UE may be configured to perform one or more operations described herein based at least in part on the configuration information.

As shown by reference number 820, the first network node may transmit a DL communication to the first UE and the second network node may receive a UL communication from the second UE. Those communications may occur during the first slot or symbol with the dynamic TDD symbols, which may cause interference if, e.g., the dynamic TDD symbols are misaligned. The communication parameters applied at reference number 805 may be used to avoid such interference. For instance, the communication parameters applied at reference number 805 may modify the TCI state, spatial relation information, or a combination thereof, of the first network node, the second network node, or both, for communications during the first slot or symbol.

As shown by reference number 825, the first network node may continue to communicate with the first UE by, e.g., outputting a DL communication to the first UE receiving a UL communication from the first UE. Those communications may occur during the second slot or symbol with the legacy TDD symbols which, e.g., allow only UL or DL communication. The communication parameters applied at reference number 810 may be used for legacy TDD communications. For instance, the communication parameters applied at reference number 810 may modify the TCI state, spatial relation information, or a combination thereof, of the first network node, the second network node, or both, for communications during the second slot or symbol.

As indicated above, FIG. 8 is provided as an example. Other examples may differ from what is described with respect to FIG. 8.

FIG. 9 is a diagram illustrating an example process 900 performed, for example, by a network node, in accordance with the present disclosure. Example process 900 is an example where the network node (e.g., network node 110) performs operations associated with per symbol/slot-type beam configuration.

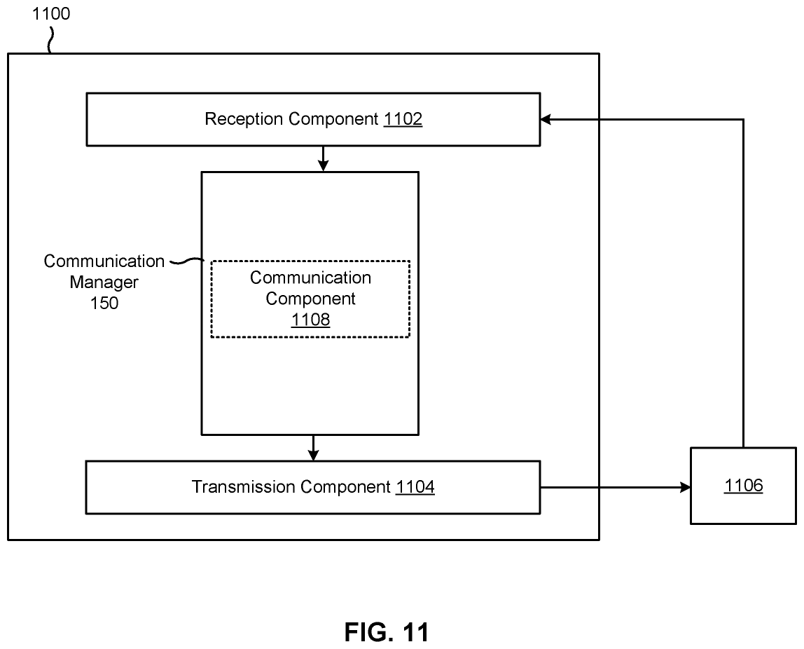

As shown in FIG. 9, in some aspects, process 900 may include performing a communication, of a DL communication or a UL communication, during a first slot or symbol (block 910). For example, the network node (e.g., using communication manager 150 and/or communication component 1108, depicted in FIG. 11) may perform a communication, of a DL communication or a UL communication, during a first slot or symbol, as described above.

As further shown in FIG. 9, in some aspects, process 900 may include performing the communication during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with sub-band full duplex (SBFD) communication or dynamic time division duplex (TDD) communication (block 920). For example, the network node (e.g., using communication manager 150 and/or communication component 1108, depicted in FIG. 11) may perform the communication during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with SBFD communication or dynamic TDD communication, as described above. In some aspects, a communication parameter of the communication during the first slot or symbol is different from a communication parameter of the communication during the second slot or symbol based at least in part on the first slot or symbol and the second slot or symbol being associated with SBFD communication or dynamic TDD communication.

Process 900 may include additional aspects, such as any single aspect or any combination of aspects described below and/or in connection with one or more other processes described elsewhere herein.

In a first aspect, the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

In a second aspect, alone or in combination with the first aspect, the first slot or symbol and the second slot or symbol are associated with dynamic TDD communication, wherein the first slot or symbol includes misaligned cross dynamic TDD symbols relative to communications by another network node and the second slot or symbol includes aligned legacy TDD symbols, and wherein the communication during the first slot or symbol is one of the DL communication or the UL communication and the communication during the second slot or symbol is one of the DL communication or the UL communication.

In a third aspect, alone or in combination with one or more of the first and second aspects, at least one of the communication parameters includes a downlink transmission configuration indication (TCI) state, including a first downlink TCI state and a second downlink TCI state, and wherein the DL communication is configured with the first downlink TCI state for transmission during the first slot or symbol and the second downlink TCI state for transmission during the second slot or symbol.

In a fourth aspect, alone or in combination with one or more of the first through third aspects, at least one of the communication parameters includes an uplink TCI state, including a first uplink TCI state and a second uplink TCI state, and wherein the UL communication is configured with the first uplink TCI state for transmission during the first slot or symbol and the second uplink TCI state for transmission during the second slot or symbol.

In a fifth aspect, alone or in combination with one or more of the first through fourth aspects, one or more of the uplink TCI states or one or more of the downlink TCI states includes a first QCL type D field.

In a sixth aspect, alone or in combination with one or more of the first through fifth aspects, one or more of the uplink TCI states or one or more of the downlink TCI states includes at least one of a QCL type A field, a QCL type B field, a QCL type C field, or a QCL type E field.

In a seventh aspect, alone or in combination with one or more of the first through sixth aspects, at least one of the communication parameters includes a downlink TCI state in the context of unified TCI framework, including a first downlink TCI state and a second downlink TCI state in the context of unified TCI framework, and wherein the DL communication is configured with the first downlink TCI state for transmission during the first slot or symbol and the second downlink TCI state for transmission during the second slot or symbol.

In an eighth aspect, alone or in combination with one or more of the first through seventh aspects, at least one of the communication parameters includes an uplink TCI state in the context of unified TCI framework, including a first uplink TCI state and a second uplink TCI state in the context of unified TCI framework, and wherein the UL communication is configured with the first uplink TCI state for transmission during the first slot or symbol and the second uplink TCI state for transmission during the second slot or symbol.

In a ninth aspect, alone or in combination with one or more of the first through eighth aspects, one or more of the uplink TCI states or one or more of the downlink TCI states includes a first QCL type D field.

In a tenth aspect, alone or in combination with one or more of the first through ninth aspects, one or more of the uplink TCI states or one or more of the downlink TCI states includes at least one of a QCL type A field, a QCL type B field, a QCL type C field, or a QCL type E field.

In an eleventh aspect, alone or in combination with one or more of the first through tenth aspects, at least one of the communication parameters includes uplink spatial relation information, including a first uplink spatial relation information and a second uplink spatial relation information, and wherein the UL communication is configured with the first uplink spatial relation information for transmission during the first slot or symbol and the second uplink spatial relation information for transmission during the second slot or symbol.

In a twelfth aspect, alone or in combination with one or more of the first through eleventh aspects, the first uplink spatial relation information includes a first QCL type D field and wherein the second uplink spatial relation information includes a second QCL type D field.

In a thirteenth aspect, alone or in combination with one or more of the first through twelfth aspects, at least one of the first uplink spatial relation information or the second uplink spatial relation information includes at least one of a QCL type A field, a QCL type B field, a QCL type C field, or a QCL type E field.

In a fourteenth aspect, alone or in combination with one or more of the first through thirteenth aspects, at least one of the communication parameters indicates at least one of an FDRA, a DL transmit power, a UL PC parameter, a UL Pmax, an MCS, a TA, a TA offset value, a TAG index parameter, a frequency hopping pattern, a time and frequency resource configuration, a PMI, an RI, a bandwidth, a BWP, or a CC.

In a fifteenth aspect, alone or in combination with one or more of the first through fourteenth aspects, process 900 includes providing or configuring one or more UEs with a first TAG for the communication during the first slot or symbol, and providing or configuring the UEs with a second TAG for the communication during the second slot or symbol.

In a sixteenth aspect, alone or in combination with one or more of the first through fifteenth aspects, at least one of the communication parameters includes a single TCI state and wherein at least one of the DL communication or the UL communication is configured with the single TCI state for communication during at least one of the first slot or symbol or the second slot or symbol.

In a seventeenth aspect, alone or in combination with one or more of the first through sixteenth aspects, the single TCI state includes two different QCL type D fields, wherein one of the QCL type D fields is for the first slot or symbol and another of the QCL type D fields is for the second slot or symbol.

In an eighteenth aspect, alone or in combination with one or more of the first through seventeenth aspects, the different QCL type D fields indicate different DL or UL beams for the first slot including SBFD symbols and the second slot including non-SBFD symbols or indicate different DL or UL beams for the first slot including misaligned TDD symbols and the second slot including aligned legacy TDD symbols.

In a nineteenth aspect, alone or in combination with one or more of the first through eighteenth aspects, the single TCI state includes two different QCL type A fields, QCL type B fields, QCL type C fields, or QCL type E fields, wherein one of the QCL type A, B, C, or E fields is for the first slot or symbol and another of the QCL type A, B, C, or E fields is for the second slot or symbol.

In a twentieth aspect, alone or in combination with one or more of the first through nineteenth aspects, at least one of the DL communication or the UL communication is configured according to a unified TCI framework, including a first downlink TCI state, a second downlink TCI state for multiple downlink channels or reference signals of the DL communication, a first uplink TCI state, and a second uplink TCI state for multiple uplink channels or reference signals of the UL communication, wherein the unified TCI framework indicates separate TCI states for the DL communication and separate TCI states for the UL communication, wherein the separate TCI states for the DL communication include the first downlink TCI state for the first slot or symbol and the second downlink TCI state for the second slot or symbol and wherein the separate TCI states for the UL communication include the first uplink TCI state and the second uplink TCI state, wherein the separate TCI states include two different QCL type A fields, QCL type B fields, QCL type C fields, QCL type D fields, or QCL type E fields, wherein one of the QCL type A, B, C, D, or E fields is for the first slot or symbol and another of the QCL type A, B, C, D, or E fields is for the second slot or symbol, and wherein the QCL type A, B, C, D, or E fields indicate different DL or UL beams for the first slot including SBFD symbols and the second slot including non-SBFD symbols or indicate different DL or UL beams for the first slot including misaligned TDD symbols and the second slot including aligned legacy TDD symbols.

In a twenty-first aspect, alone or in combination with one or more of the first through twentieth aspects, the DL communication is configured without repetition in SBFD symbols and non-SBFD symbols and configured with different downlink TCI states.

In a twenty-second aspect, alone or in combination with one or more of the first through twenty-first aspects, the DL communication includes a PDSCH or a PDCCH communication.

In a twenty-third aspect, alone or in combination with one or more of the first through twenty-second aspects, the DL communication is configured without repetition in misaligned dynamic TDD symbols and aligned legacy TDD symbols and configured with different downlink TCI states.

In a twenty-fourth aspect, alone or in combination with one or more of the first through twenty-third aspects, the DL communication includes a PDSCH communication or a PDCCH communication.

In a twenty-fifth aspect, alone or in combination with one or more of the first through twenty-fourth aspects, the DL communication is configured with repetition in SBFD symbols and non-SBFD symbols and configured with different downlink TCI states.

In a twenty-sixth aspect, alone or in combination with one or more of the first through twenty-fifth aspects, the DL communication includes a PDSCH communication or a PDCCH communication.

In a twenty-seventh aspect, alone or in combination with one or more of the first through twenty-sixth aspects, the DL communication is configured with repetition in misaligned dynamic TDD symbols and aligned legacy TDD symbols and configured with different downlink TCI states.

In a twenty-eighth aspect, alone or in combination with one or more of the first through twenty-seventh aspects, the DL communication includes a PDSCH communication or a PDCCH communication.

In a twenty-ninth aspect, alone or in combination with one or more of the first through twenty-eighth aspects, the UL communication is configured without repetition in SBFD symbols and non-SBFD symbols and configured with different uplink TCI states or different uplink spatial relation information.

In a thirtieth aspect, alone or in combination with one or more of the first through twenty-ninth aspects, the UL communication includes at least one of a PUCCH communication or a PUSCH communication.

In a thirty-first aspect, alone or in combination with one or more of the first through thirtieth aspects, the UL communication is configured without repetition in misaligned dynamic TDD symbols and configured with different uplink TCI states or different uplink spatial relation information.

In a thirty-second aspect, alone or in combination with one or more of the first through thirty-first aspects, the UL communication includes at least one of a PUCCH communication or a PUSCH communication.

In a thirty-third aspect, alone or in combination with one or more of the first through thirty-second aspects, the UL communication is configured with repetition in SBFD symbols and non-SBFD symbols and configured with different uplink TCI states or with different uplink spatial relation information.

In a thirty-fourth aspect, alone or in combination with one or more of the first through thirty-third aspects, the UL communication includes at least one of a PUCCH communication or a PUSCH communication.

In a thirty-fifth aspect, alone or in combination with one or more of the first through thirty-fourth aspects, the UL communication is configured with repetition in misaligned dynamic TDD symbols and aligned legacy TDD symbols and configured with different uplink TCI states or with different uplink spatial relation information.

In a thirty-sixth aspect, alone or in combination with one or more of the first through thirty-fifth aspects, the UL communication includes at least one of a PUCCH communication or a PUSCH communication.

In a thirty-seventh aspect, alone or in combination with one or more of the first through thirty-sixth aspects, the UL communication includes a sounding reference signal communication in one or more of SBFD symbols, non-SBFD symbols, misaligned dynamic TDD symbols, or aligned legacy TDD symbols.

In a thirty-eighth aspect, alone or in combination with one or more of the first through thirty-seventh aspects, the DL communication includes a channel strength indicator reference signal communication in one or more of SBFD symbols, non-SBFD symbols, misaligned dynamic TDD symbols, or aligned legacy TDD symbols.

In a thirty-ninth aspect, alone or in combination with one or more of the first through thirty-eighth aspects, the communication includes a TBoMS across one or more of SBFD symbols, non-SBFD symbols, misaligned dynamic TDD symbols, or aligned legacy TDD symbols.

In a fortieth aspect, alone or in combination with one or more of the first through thirty-ninth aspects, the DL communication includes a single DCI scheduled multi-PDSCH communication in one or more of SBFD symbols, non-SBFD symbols, misaligned dynamic TDD symbols, or aligned legacy TDD symbols.

In a forty-first aspect, alone or in combination with one or more of the first through fortieth aspects, the UL communication includes a single scheduled multi-PUSCH communication in one or more of SBFD symbols, non-SBFD symbols, misaligned dynamic TDD symbols, or aligned legacy TDD symbols.

In a forty-second aspect, alone or in combination with one or more of the first through forty-first aspects, process 900 includes outputting or configuring DCI indicating at least one of the communication parameters.

In a forty-third aspect, alone or in combination with one or more of the first through forty-second aspects, process 900 includes outputting or configuring RRC signaling indicating at least one of the communication parameters.

In a forty-fourth aspect, alone or in combination with one or more of the first through forty-third aspects, process 900 includes outputting or configuring MAC-CE signaling indicating at least one of the communication parameters.

In a forty-fifth aspect, alone or in combination with one or more of the first through forty-fourth aspects, at least one of the communication parameters includes uplink spatial relation information, including a first uplink spatial relation information and a second uplink spatial relation information, and wherein the UL communication is configured with the first uplink spatial relation information for transmission during the first slot or symbol and the second uplink spatial relation information for transmission during the second slot or symbol.

In a forty-sixth aspect, alone or in combination with one or more of the first through forty-fifth aspects, the first uplink spatial relation information includes a first QCL type D field and wherein the second uplink spatial relation information includes a second QCL type D field.

In a forty-seventh aspect, alone or in combination with one or more of the first through forty-sixth aspects, at least one of the first uplink spatial relation information or the second uplink spatial relation information includes at least one of a QCL type A field, a QCL type B field, a QCL type C field, or a QCL type E field.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

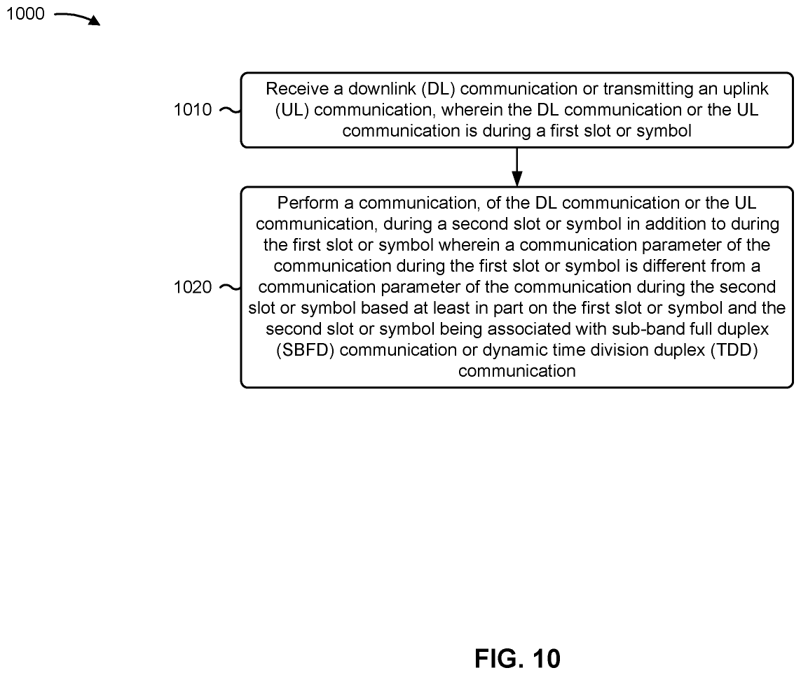

FIG. 10 is a diagram illustrating an example process 1000 performed, for example, by a UE, in accordance with the present disclosure. Example process 1000 is an example where the UE (e.g., UE 120) performs operations associated with per symbol/slot-type beam configuration.

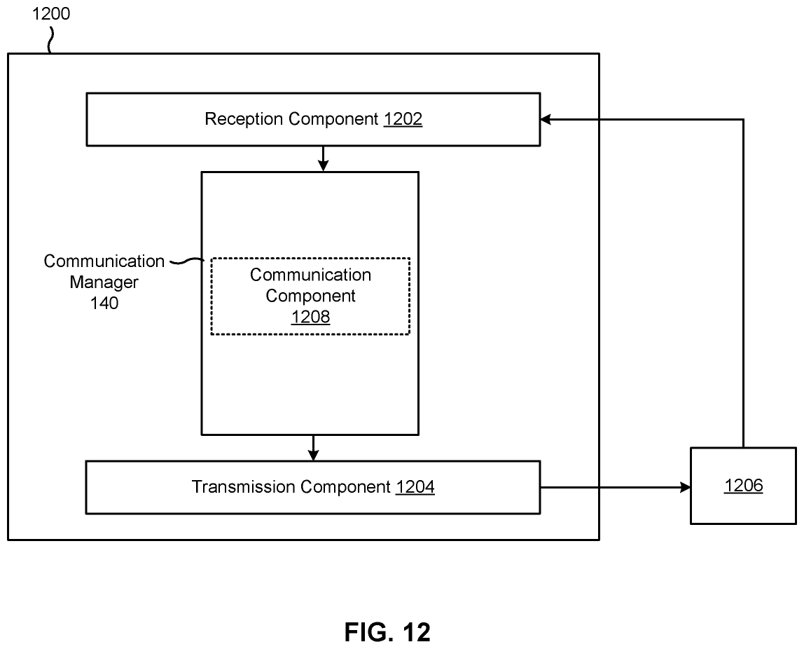

As shown in FIG. 10, in some aspects, process 1000 may include receiving a DL communication or transmitting a UL communication, wherein the DL communication or the UL communication is during a first slot or symbol (block 1010). For example, the UE (e.g., using communication manager 140 and/or reception component 1202, depicted in FIG. 12) may receive a DL communication or transmitting a UL communication, wherein the DL communication or the UL communication is during a first slot or symbol, as described above.

As further shown in FIG. 10, in some aspects, process 1000 may include performing a communication, of the DL communication or the UL communication, during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with network side SBFD communication or dynamic TDD communication (block 1020). For example, the UE (e.g., using communication manager 140 and/or communication component 1208, depicted in FIG. 12) may perform a communication, of the DL communication or the UL communication, during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with network side SBFD communication or dynamic TDD communication, as described above. In some aspects, a communication parameter of the communication during the first slot or symbol is different from a communication parameter of the communication during the second slot or symbol based at least in part on the first slot or symbol and the second slot or symbol being associated with network side SBFD communication or dynamic TDD communication.

Process 1000 may include additional aspects, such as any single aspect or any combination of aspects described below and/or in connection with one or more other processes described elsewhere herein.

In a first aspect, the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

In a second aspect, alone or in combination with the first aspect, the first slot or symbol and the second slot or symbol are associated with dynamic TDD communication, wherein the first slot or symbol includes misaligned cross dynamic TDD symbols relative to communications by another network node and the second slot or symbol includes aligned legacy TDD symbols, and wherein the communication during the first slot or symbol is one of the DL communication or the UL communication and the communication during the second slot or symbol is one of the DL communication or the UL communication.

In a third aspect, alone or in combination with one or more of the first and second aspects, at least one of the communication parameters includes a downlink TCI state, including a first downlink TCI state and a second downlink TCI state, and wherein the DL communication is configured with the first downlink TCI state for transmission during the first slot or symbol and the second downlink TCI state for transmission during the second slot or symbol.

In a fourth aspect, alone or in combination with one or more of the first through third aspects, at least one of the communication parameters includes an uplink TCI state, including a first uplink TCI state and a second uplink TCI state, and wherein the UL communication is configured with the first uplink TCI state for transmission during the first slot or symbol and the second uplink TCI state for transmission during the second slot or symbol.

In a fifth aspect, alone or in combination with one or more of the first through fourth aspects, one or more of the uplink TCI states or one or more of the downlink TCI states includes a first QCL type D field.

In a sixth aspect, alone or in combination with one or more of the first through fifth aspects, one or more of the uplink TCI states or one or more of the downlink TCI states includes at least one of a QCL type A field, a QCL type B field, a QCL type C field, or a QCL type E field.

In a seventh aspect, alone or in combination with one or more of the first through sixth aspects, at least one of the communication parameters includes a downlink TCI state in the context of unified TCI framework, including a first downlink TCI state and a second downlink TCI state in the context of unified TCI framework, and wherein the DL communication is configured with the first downlink TCI state for transmission during the first slot or symbol and the second downlink TCI state for transmission during the second slot or symbol.

In an eighth aspect, alone or in combination with one or more of the first through seventh aspects, at least one of the communication parameters indicates at least one of an FDRA, a DL transmit power, a UL PC parameter, a UL Pmax, an MCS, a TA, a TA offset value, a TAG index parameter, a frequency hopping pattern, a time and frequency resource configuration, a PMI, an RI, a bandwidth, a BWP, or a CC.

In a ninth aspect, alone or in combination with one or more of the first through eighth aspects, process 1000 includes receiving a first TAG for the communication during the first slot or symbol, and receiving a second TAG for the communication during the second slot or symbol.

In a tenth aspect, alone or in combination with one or more of the first through ninth aspects, at least one of the communication parameters includes a single TCI state and wherein at least one of the DL communication or the UL communication is configured with the single TCI state for communication during at least one of the first slot or symbol or the second slot or symbol.

In an eleventh aspect, alone or in combination with one or more of the first through tenth aspects, the single TCI state includes two different QCL type D fields, wherein one of the QCL type D fields is for the first slot or symbol and another of the QCL type D fields is for the second slot or symbol.

In a twelfth aspect, alone or in combination with one or more of the first through eleventh aspects, the different QCL type D fields indicate different DL or UL beams for the first slot including SBFD symbols and the second slot including non-SBFD symbols or indicate different DL or UL beams for the first slot including misaligned TDD symbols and the second slot including aligned legacy TDD symbols.

In a thirteenth aspect, alone or in combination with one or more of the first through twelfth aspects, the single TCI state includes two different QCL type A fields, QCL type B fields, QCL type C fields, or QCL type E fields, wherein one of the QCL type A, B, C, or E fields is for the first slot or symbol and another of the QCL type A, B, C, or E fields is for the second slot or symbol.

In a fourteenth aspect, alone or in combination with one or more of the first through thirteenth aspects, at least one of the DL communication or the UL communication is configured according to a unified TCI framework, including a first downlink TCI state, a second downlink TCI state for multiple downlink channels or reference signals of the DL communication, a first uplink TCI state, and a second uplink TCI state for multiple uplink channels or reference signals of the UL communication, wherein the unified TCI framework indicates separate TCI states for the DL communication and separate TCI states for the UL communication, wherein the separate TCI states for the DL communication include the first downlink TCI state for the first slot or symbol and the second downlink TCI state for the second slot or symbol and wherein the separate TCI states for the UL communication include the first uplink TCI state and the second uplink TCI state, wherein the separate TCI states include two different QCL type A fields, QCL type B fields, QCL type C fields, QCL type D fields, or QCL type E fields, wherein one of the QCL type A, B, C, D, or E fields is for the first slot or symbol and another of the QCL type A, B, C, D, or E fields is for the second slot or symbol, and wherein the QCL type A, B, C, D, or E fields indicate different DL or UL beams for the first slot including SBFD symbols and the second slot including non-SBFD symbols or indicate different DL or UL beams for the first slot including misaligned TDD symbols and the second slot including aligned legacy TDD symbols.

In a fifteenth aspect, alone or in combination with one or more of the first through fourteenth aspects, the DL communication is configured without repetition in SBFD symbols and non-SBFD symbols and configured with different downlink TCI states.

In a sixteenth aspect, alone or in combination with one or more of the first through fifteenth aspects, the DL communication includes a PDSCH or a PDCCH communication.

In a seventeenth aspect, alone or in combination with one or more of the first through sixteenth aspects, the DL communication is configured without repetition in misaligned dynamic TDD symbols and aligned legacy TDD symbols and configured with different downlink TCI states.

In an eighteenth aspect, alone or in combination with one or more of the first through seventeenth aspects, the DL communication includes a PDSCH or a PDCCH communication.

In a nineteenth aspect, alone or in combination with one or more of the first through eighteenth aspects, the DL communication is configured with repetition in SBFD symbols and non-SBFD symbols and configured with different downlink TCI states.

In a twentieth aspect, alone or in combination with one or more of the first through nineteenth aspects, the DL communication includes a PDSCH or a PDCCH communication.

In a twenty-first aspect, alone or in combination with one or more of the first through twentieth aspects, the DL communication is configured with repetition in misaligned dynamic TDD symbols and aligned legacy TDD symbols and configured with different downlink TCI states.

In a twenty-second aspect, alone or in combination with one or more of the first through twenty-first aspects, the DL communication includes a PDSCH or a PDCCH communication.

In a twenty-third aspect, alone or in combination with one or more of the first through twenty-second aspects, the UL communication is configured without repetition in SBFD symbols and non-SBFD symbols and configured with different uplink TCI states or different uplink spatial relation information.

In a twenty-fourth aspect, alone or in combination with one or more of the first through twenty-third aspects, the UL communication includes at least one of a PUCCH communication or a PUSCH communication.

In a twenty-fifth aspect, alone or in combination with one or more of the first through twenty-fourth aspects, the UL communication is configured without repetition in misaligned dynamic TDD symbols and configured with different uplink TCI states or different uplink spatial relation information.

In a twenty-sixth aspect, alone or in combination with one or more of the first through twenty-fifth aspects, the UL communication includes at least one of a PUCCH communication or a PUSCH communication.

In a twenty-seventh aspect, alone or in combination with one or more of the first through twenty-sixth aspects, the UL communication is configured with repetition in SBFD symbols and non-SBFD symbols and configured with different uplink TCI states or with different uplink spatial relation information.

In a twenty-eighth aspect, alone or in combination with one or more of the first through twenty-seventh aspects, the UL communication includes at least one of a PUCCH communication or a PUSCH communication.

In a twenty-ninth aspect, alone or in combination with one or more of the first through twenty-eighth aspects, the UL communication is configured with repetition in misaligned dynamic TDD symbols and aligned legacy TDD symbols and configured with different uplink TCI states or with different uplink spatial relation information.

In a thirtieth aspect, alone or in combination with one or more of the first through twenty-ninth aspects, the UL communication includes at least one of a PUCCH communication or a PUSCH communication.

In a thirty-first aspect, alone or in combination with one or more of the first through thirtieth aspects, the UL communication includes a sounding reference signal communication in one or more of SBFD symbols, non-SBFD symbols, misaligned dynamic TDD symbols, or aligned legacy TDD symbols.

In a thirty-second aspect, alone or in combination with one or more of the first through thirty-first aspects, the DL communication includes a channel strength indicator reference signal communication in one or more of SBFD symbols, non-SBFD symbols, misaligned dynamic TDD symbols, or aligned legacy TDD symbols.

In a thirty-third aspect, alone or in combination with one or more of the first through thirty-second aspects, the communication includes a TBoMS across one or more of SBFD symbols, non-SBFD symbols, misaligned dynamic TDD symbols, or aligned legacy TDD symbols.

In a thirty-fourth aspect, alone or in combination with one or more of the first through thirty-third aspects, the DL communication includes a single DCI scheduled multi-PDSCH communication in one or more of SBFD symbols, non-SBFD symbols, misaligned dynamic TDD symbols, or aligned legacy TDD symbols.

In a thirty-fifth aspect, alone or in combination with one or more of the first through thirty-fourth aspects, the UL communication includes a single scheduled multi-PUSCH communication in one or more of SBFD symbols, non-SBFD symbols, misaligned dynamic TDD symbols, or aligned legacy TDD symbols.

In a thirty-sixth aspect, alone or in combination with one or more of the first through thirty-fifth aspects, process 1000 includes receiving DCI indicating at least one of the communication parameters.

In a thirty-seventh aspect, alone or in combination with one or more of the first through thirty-sixth aspects, process 1000 includes receiving RRC signaling indicating at least one of the communication parameters.

In a thirty-eighth aspect, alone or in combination with one or more of the first through thirty-seventh aspects, process 1000 includes receiving MAC-CE signaling indicating at least one of the communication parameters.

In a thirty-ninth aspect, alone or in combination with one or more of the first through thirty-eighth aspects, process 1000 includes applying the communication parameter to the first slot or symbol based at least in part on the first slot or symbol being associated with SBFD symbols or misaligned dynamic TDD symbols.

In a fortieth aspect, alone or in combination with one or more of the first through thirty-ninth aspects, process 1000 includes applying the communication parameter to the second slot or symbol based at least in part on the second slot or symbol being associated with non-SBFD symbols or legacy aligned TDD symbols.

In a forty-first aspect, alone or in combination with one or more of the first through fortieth aspects, process 1000 includes receiving an explicit indication associating the communication parameter of the first slot or symbol to communications during the first slot or symbol.

In a forty-second aspect, alone or in combination with one or more of the first through forty-first aspects, process 1000 includes receiving an explicit indication associating the communication parameter of the second slot or symbol to communications during the second slot or symbol.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a communication component 1108, among other examples.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node described in connection with FIG. 2. In some aspects, the transmission component 1104 may be co-located with the reception component 1102 in a transceiver.

The communication component 1108 may perform a communication, of a DL communication or a UL communication, during a first slot or symbol. The communication component 1108 may perform the communication during a second slot or symbol in addition to during the first slot or symbol wherein a communication parameter of the communication during the first slot or symbol is different from a communication parameter of the communication during the second slot or symbol based at least in part on the first slot or symbol and the second slot or symbol being associated with SBFD communication or dynamic TDD communication.

The communication component 1108 may provide or configure one or more UEs with a first TAG for the communication during the first slot or symbol.

The communication component 1108 may provide or configure the UEs with a second TAG for the communication during the second slot or symbol.

The transmission component 1104 may output or configure DCI indicating at least one of the communication parameters.

The transmission component 1104 may output or configure RRC signaling indicating at least one of the communication parameters.

The transmission component 1104 may output or configure MAC-CE signaling indicating at least one of the communication parameters.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include a communication component 1208, among other examples.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The reception component 1202 may receive a DL communication or transmitting a UL communication, wherein the DL communication or the UL communication is during a first slot or symbol. The communication component 1208 may perform a communication, of the DL communication or the UL communication, during a second slot or symbol in addition to during the first slot or symbol wherein a communication parameter of the communication during the first slot or symbol is different from a communication parameter of the communication during the second slot or symbol based at least in part on the first slot or symbol and the second slot or symbol being associated with network side SBFD communication or dynamic TDD communication.

The reception component 1202 may receive a first TAG for the communication during the first slot or symbol.

The reception component 1202 may receive a second TAG for the communication during the second slot or symbol.

The reception component 1202 may receive DCI indicating at least one of the communication parameters.

The reception component 1202 may receive RRC signaling indicating at least one of the communication parameters.

The reception component 1202 may receive MAC-CE signaling indicating at least one of the communication parameters.

The communication component 1208 may apply the communication parameter to the first slot or symbol based at least in part on the first slot or symbol being associated with SBFD symbols or misaligned dynamic TDD symbols.

The communication component 1208 may apply the communication parameter to the second slot or symbol based at least in part on the second slot or symbol being associated with non-SBFD symbols or legacy aligned TDD symbols.

The reception component 1202 may receive an explicit indication associating the communication parameter of the first slot or symbol to communications during the first slot or symbol.

The reception component 1202 may receive an explicit indication associating the communication parameter of the second slot or symbol to communications during the second slot or symbol.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a network node, comprising: performing a communication, of a DL communication or a UL communication, during a first slot or symbol; and performing the communication during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with SBFD communication or dynamic TDD communication.

Aspect 2: The method of Aspect 1, wherein the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

Aspect 3: The method of any of Aspects 1-2, wherein the first slot or symbol and the second slot or symbol are associated with dynamic TDD communication, wherein the first slot or symbol includes misaligned cross dynamic TDD symbols relative to communications by another network node and the second slot or symbol includes aligned legacy TDD symbols, and wherein the communication during the first slot or symbol is one of the DL communication or the UL communication and the communication during the second slot or symbol is one of the DL communication or the UL communication.

Aspect 4: The method of any of Aspects 1-3, wherein at least one of the communication parameters includes a downlink TCI state, including a first downlink TCI state and a second downlink TCI state, and wherein the DL communication is configured with the first downlink TCI state for transmission during the first slot or symbol and the second downlink TCI state for transmission during the second slot or symbol.

Aspect 5: The method of Aspect 4, wherein at least one of the communication parameters includes an uplink TCI state, including a first uplink TCI state and a second uplink TCI state, and wherein the UL communication is configured with the first uplink TCI state for transmission during the first slot or symbol and the second uplink TCI state for transmission during the second slot or symbol.

Aspect 6: The method of Aspect 5, wherein one or more of the uplink TCI states or one or more of the downlink TCI states includes a first QCL type D field.

Aspect 7: The method of Aspect 5, wherein one or more of the uplink TCI states or one or more of the downlink TCI states includes at least one of a QCL type A field, a QCL type B field, a QCL type C field, or a QCL type E field.

Aspect 8: The method of any of Aspects 1-7, wherein at least one of the communication parameters includes a downlink TCI state in the context of unified TCI framework, including a first downlink TCI state and a second downlink TCI state in the context of unified TCI framework, and wherein the DL communication is configured with the first downlink TCI state for transmission during the first slot or symbol and the second downlink TCI state for transmission during the second slot or symbol.

Aspect 9: The method of Aspect 8, wherein at least one of the communication parameters includes an uplink TCI state in the context of unified TCI framework, including a first uplink TCI state and a second uplink TCI state in the context of unified TCI framework, and wherein the UL communication is configured with the first uplink TCI state for transmission during the first slot or symbol and the second uplink TCI state for transmission during the second slot or symbol.

Aspect 10: The method of Aspect 9, wherein one or more of the uplink TCI states or one or more of the downlink TCI states includes a first QCL type D field.

Aspect 11: The method of Aspect 9, wherein one or more of the uplink TCI states or one or more of the downlink TCI states includes at least one of a QCL type A field, a QCL type B field, a QCL type C field, or a QCL type E field.

Aspect 12: The method of any of Aspects 1-11, wherein at least one of the communication parameters includes uplink spatial relation information, including a first uplink spatial relation information and a second uplink spatial relation information, and wherein the UL communication is configured with the first uplink spatial relation information for transmission during the first slot or symbol and the second uplink spatial relation information for transmission during the second slot or symbol.

Aspect 13: The method of Aspect 12, wherein the first uplink spatial relation information includes a first QCL type D field and wherein the second uplink spatial relation information includes a second QCL type D field.

Aspect 14: The method of Aspect 12, wherein at least one of the first uplink spatial relation information or the second uplink spatial relation information includes at least one of a QCL type A field, a QCL type B field, a QCL type C field, or a QCL type E field.

Aspect 15: The method of any of Aspects 1-14, wherein at least one of the communication parameters indicates at least one of an FDRA, a DL transmit power, a UL PC parameter, a UL Pmax, an MCS, a TA, a TA offset value, a TAG index parameter, a frequency hopping pattern, a time and frequency resource configuration, a PMI, an RI, a bandwidth, a BWP, or a CC.

Aspect 16: The method of Aspect 15, further comprising: providing or configuring one or more UEs with a first TAG for the communication during the first slot or symbol; and providing or configuring the UEs with a second TAG for the communication during the second slot or symbol.

Aspect 17: The method of any of Aspects 1-16, wherein at least one of the communication parameters includes a single TCI state and wherein at least one of the DL communication or the UL communication is configured with the single TCI state for communication during at least one of the first slot or symbol or the second slot or symbol.

Aspect 18: The method of Aspect 17, wherein the single TCI state includes two different QCL type D fields, wherein one of the QCL type D fields is for the first slot or symbol and another of the QCL type D fields is for the second slot or symbol.

Aspect 19: The method of Aspect 18, wherein the different QCL type D fields indicate different DL or UL beams for the first slot including SBFD symbols and the second slot including non-SBFD symbols or indicate different DL or UL beams for the first slot including misaligned TDD symbols and the second slot including aligned legacy TDD symbols.

Aspect 20: The method of Aspect 19, wherein the single TCI state includes two different QCL type A fields, QCL type B fields, QCL type C fields, or QCL type E fields, wherein one of the QCL type A, B, C, or E fields is for the first slot or symbol and another of the QCL type A, B, C, or E fields is for the second slot or symbol.

Aspect 21: The method of Aspect 17, wherein at least one of the DL communication or the UL communication is configured according to a unified TCI framework, including a first downlink TCI state, a second downlink TCI state for multiple downlink channels or reference signals of the DL communication, a first uplink TCI state, and a second uplink TCI state for multiple uplink channels or reference signals of the UL communication, wherein the unified TCI framework indicates separate TCI states for the DL communication and separate TCI states for the UL communication, wherein the separate TCI states for the DL communication include the first downlink TCI state for the first slot or symbol and the second downlink TCI state for the second slot or symbol and wherein the separate TCI states for the UL communication include the first uplink TCI state and the second uplink TCI state, wherein the separate TCI states include two different QCL type A fields, QCL type B fields, QCL type C fields, QCL type D fields, or QCL type E fields, wherein one of the QCL type A, B, C, D, or E fields is for the first slot or symbol and another of the QCL type A, B, C, D, or E fields is for the second slot or symbol, and wherein the QCL type A, B, C, D, or E fields indicate different DL or UL beams for the first slot including SBFD symbols and the second slot including non-SBFD symbols or indicate different DL or UL beams for the first slot including misaligned TDD symbols and the second slot including aligned legacy TDD symbols.

Aspect 22: The method of any of Aspects 1-21, wherein the DL communication is configured without repetition in SBFD symbols and non-SBFD symbols and configured with different downlink TCI states.

Aspect 23: The method of Aspect 22, wherein the DL communication includes a PDSCH or a PDCCH communication.

Aspect 24: The method of any of Aspects 1-23, wherein the DL

communication is configured without repetition in misaligned dynamic TDD symbols and aligned legacy TDD symbols and configured with different downlink TCI states.

Aspect 25: The method of Aspect 24, wherein the DL communication includes a PDSCH or a PDCCH communication.

Aspect 26: The method of any of Aspects 1-25, wherein the DL

communication is configured with repetition in SBFD symbols and non-SBFD symbols and configured with different downlink TCI states.

Aspect 27: The method of Aspect 26, wherein the DL communication includes a PDSCH or a PDCCH communication.

Aspect 28: The method of any of Aspects 1-27, wherein the DL communication is configured with repetition in misaligned dynamic TDD symbols and aligned legacy TDD symbols and configured with different downlink TCI states.

Aspect 29: The method of Aspect 28, wherein the DL communication includes a PDSCH or a PDCCH communication.

Aspect 30: The method of any of Aspects 1-29, wherein the UL communication is configured without repetition in SBFD symbols and non-SBFD symbols and configured with different uplink TCI states or different uplink spatial relation information.

Aspect 31: The method of Aspect 30, wherein the UL communication includes at least one of a PUCCH communication or a PUSCH communication.

Aspect 32: The method of any of Aspects 1-31, wherein the UL communication is configured without repetition in misaligned dynamic TDD symbols and configured with different uplink TCI states or different uplink spatial relation information.

Aspect 33: The method of Aspect 26, wherein the UL communication includes at least one of a PUCCH communication or a PUSCH communication.

Aspect 34: The method of any of Aspects 1-33, wherein the UL communication is configured with repetition in SBFD symbols and non-SBFD symbols and configured with different uplink TCI states or with different uplink spatial relation information.

Aspect 35: The method of Aspect 34, wherein the UL communication includes at least one of a PUCCH communication or a PUSCH communication.

Aspect 36: The method of any of Aspects 1-35, wherein the UL communication is configured with repetition in misaligned dynamic TDD symbols and aligned legacy TDD symbols and configured with different uplink TCI states or with different uplink spatial relation information.

Aspect 37: The method of Aspect 36, wherein the UL communication includes at least one of a PUCCH communication or a PUSCH communication.

Aspect 38: The method of any of Aspects 1-37, wherein the UL communication includes a sounding reference signal communication in one or more of SBFD symbols, non-SBFD symbols, misaligned dynamic TDD symbols, or aligned legacy TDD symbols.

Aspect 39: The method of any of Aspects 1-38, wherein the DL communication includes a channel strength indicator reference signal communication in one or more of SBFD symbols, non-SBFD symbols, misaligned dynamic TDD symbols, or aligned legacy TDD symbols.

Aspect 40: The method of any of Aspects 1-39, wherein the communication includes a transport block over multiple slots (TBoMS) across one or more of SBFD symbols, non-SBFD symbols, misaligned dynamic TDD symbols, or aligned legacy TDD symbols.

Aspect 41: The method of any of Aspects 1-40, wherein the DL communication includes a single DCI scheduled multi-PDSCH communication in one or more of SBFD symbols, non-SBFD symbols, misaligned dynamic TDD symbols, or aligned legacy TDD symbols.

Aspect 42: The method of any of Aspects 1-41, wherein the UL communication includes a single scheduled multi-PUSCH communication in one or more of SBFD symbols, non-SBFD symbols, misaligned dynamic TDD symbols, or aligned legacy TDD symbols.

Aspect 43: The method of any of Aspects 1-42, further comprising outputting or configuring downlink control information (DCI) indicating at least one of the communication parameters.

Aspect 44: The method of any of Aspects 1-43, further comprising outputting or configuring radio resource control (RRC) signaling indicating at least one of the communication parameters.

Aspect 45: The method of any of Aspects 1-44, further comprising outputting or configuring medium access control (MAC) control element (CE) (MAC-CE) signaling indicating at least one of the communication parameters.

Aspect 46: A method of wireless communication performed by a user equipment (UE), comprising: receiving a DL communication or transmitting a UL communication, wherein the DL communication or the UL communication is during a first slot or symbol; and performing a communication, of the DL communication or the UL communication, during a second slot or symbol in addition to during the first slot or symbol, wherein a communication parameter of the communication during the first slot or symbol is different from a communication parameter of the communication during the second slot or symbol based at least in part on the first slot or symbol and the second slot or symbol being associated with network side SBFD communication or dynamic TDD communication.

Aspect 47: The method of Aspect 46, wherein the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

Aspect 48: The method of any of Aspects 46-47, wherein the first slot or symbol and the second slot or symbol are associated with dynamic TDD communication, wherein the first slot or symbol includes misaligned cross dynamic TDD symbols relative to communications by another network node and the second slot or symbol includes aligned legacy TDD symbols, and wherein the communication during the first slot or symbol is one of the DL communication or the UL communication and the communication during the second slot or symbol is one of the DL communication or the UL communication.

Aspect 49: The method of any of Aspects 46-48, wherein at least one of the communication parameters includes a downlink TCI state, including a first downlink TCI state and a second downlink TCI state, and wherein the DL communication is configured with the first downlink TCI state for transmission during the first slot or symbol and the second downlink TCI state for transmission during the second slot or symbol.

Aspect 50: The method of Aspect 49, wherein at least one of the communication parameters includes an uplink TCI state, including a first uplink TCI state and a second uplink TCI state, and wherein the UL communication is configured with the first uplink TCI state for transmission during the first slot or symbol and the second uplink TCI state for transmission during the second slot or symbol.

Aspect 51: The method of Aspect 50, wherein one or more of the uplink TCI states or one or more of the downlink TCI states includes a first QCL type D field.

Aspect 52: The method of Aspect 50, wherein one or more of the uplink TCI states or one or more of the downlink TCI states includes at least one of a QCL type A field, a QCL type B field, a QCL type C field, or a QCL type E field.

Aspect 53: The method of any of Aspects 46-52, wherein at least one of the communication parameters includes a downlink TCI state in the context of unified TCI framework, including a first downlink TCI state and a second downlink TCI state in the context of unified TCI framework, and wherein the DL communication is configured with the first downlink TCI state for transmission during the first slot or symbol and the second downlink TCI state for transmission during the second slot or symbol.

Aspect 54: The method of Aspect 53, wherein at least one of the communication parameters includes an uplink TCI state in the context of unified TCI framework, including a first uplink TCI state and a second uplink TCI state in the context of unified TCI framework, and wherein the UL communication is configured with the first uplink TCI state for transmission during the first slot or symbol and the second uplink TCI state for transmission during the second slot or symbol.

Aspect 55: The method of Aspect 54, wherein one or more of the uplink TCI states or one or more of the downlink TCI states includes a first QCL type D field.

Aspect 56: The method of Aspect 55, wherein one or more of the uplink TCI states or one or more of the downlink TCI states includes at least one of a QCL type A field, a QCL type B field, a QCL type C field, or a QCL type E field.

Aspect 57: The method of Aspect 46, wherein at least one of the communication parameters includes uplink spatial relation information, including a first uplink spatial relation information and a second uplink spatial relation information, and wherein the UL communication is configured with the first uplink spatial relation information for transmission during the first slot or symbol and the second uplink spatial relation information for transmission during the second slot or symbol.

Aspect 58: The method of Aspect 57, wherein the first uplink spatial relation information includes a first QCL type D field and wherein the second uplink spatial relation information includes a second QCL type D field.

Aspect 59: The method of Aspect 57, wherein at least one of the first uplink spatial relation information or the second uplink spatial relation information includes at least one of a QCL type A field, a QCL type B field, a QCL type C field, or a QCL type E field.

Aspect 60: The method of any of Aspects 46-59, wherein at least one of the communication parameters indicates at least one of an FDRA, a DL transmit power, a UL PC parameter, a UL Pmax, an MCS, a TA, a TA offset value, a TAG index parameter, a frequency hopping pattern, a time and frequency resource configuration, a PMI, an RI, a bandwidth, a BWP, or a CC.

Aspect 61: The method of Aspect 60, further comprising: receiving a first TAG for the communication during the first slot or symbol; and receiving a second TAG for the communication during the second slot or symbol.

Aspect 62: The method of any of Aspects 46-61, wherein at least one of the communication parameters includes a single TCI state and wherein at least one of the DL communication or the UL communication is configured with the single TCI state for communication during at least one of the first slot or symbol or the second slot or symbol.

Aspect 63: The method of Aspect 62, wherein the single TCI state includes two different QCL type D fields, wherein one of the QCL type D fields is for the first slot or symbol and another of the QCL type D fields is for the second slot or symbol.

Aspect 64: The method of Aspect 63, wherein the different QCL type D fields indicate different DL or UL beams for the first slot including SBFD symbols and the second slot including non-SBFD symbols or indicate different DL or UL beams for the first slot including misaligned TDD symbols and the second slot including aligned legacy TDD symbols.

Aspect 65: The method of Aspect 64, wherein the single TCI state includes two different QCL type A fields, QCL type B fields, QCL type C fields, or QCL type E fields, wherein one of the QCL type A, B, C, or E fields is for the first slot or symbol and another of the QCL type A, B, C, or E fields is for the second slot or symbol.

Aspect 66: The method of Aspect 62, wherein at least one of the DL communication or the UL communication is configured according to a unified TCI framework, including a first downlink TCI state, a second downlink TCI state for multiple downlink channels or reference signals of the DL communication, a first uplink TCI state, and a second uplink TCI state for multiple uplink channels or reference signals of the UL communication, wherein the unified TCI framework indicates separate TCI states for the DL communication and separate TCI states for the UL communication, wherein the separate TCI states for the DL communication include the first downlink TCI state for the first slot or symbol and the second downlink TCI state for the second slot or symbol and wherein the separate TCI states for the UL communication include the first uplink TCI state and the second uplink TCI state, wherein the separate TCI states include two different QCL type A fields, QCL type B fields, QCL type C fields, QCL type D fields, or QCL type E fields, wherein one of the QCL type A, B, C, D, or E fields is for the first slot or symbol and another of the QCL type A, B, C, D, or E fields is for the second slot or symbol, and wherein the QCL type A, B, C, D, or E fields indicate different DL or UL beams for the first slot including SBFD symbols and the second slot including non-SBFD symbols or indicate different DL or UL beams for the first slot including misaligned TDD symbols and the second slot including aligned legacy TDD symbols.

Aspect 67: The method of any of Aspects 46-66, wherein the DL communication is configured without repetition in SBFD symbols and non-SBFD symbols and configured with different downlink TCI states.

Aspect 68: The method of Aspect 67, wherein the DL communication includes a PDSCH or a PDCCH communication.

Aspect 69: The method of any of Aspects 46-68, wherein the DL communication is configured without repetition in misaligned dynamic TDD symbols and aligned legacy TDD symbols and configured with different downlink TCI states.

Aspect 70: The method of Aspect 69, wherein the DL communication includes a PDSCH or a PDCCH communication.

Aspect 71: The method of any of Aspects 46-70, wherein the DL communication is configured with repetition in SBFD symbols and non-SBFD symbols and configured with different downlink TCI states.

Aspect 72: The method of Aspect 71, wherein the DL communication includes a PDSCH or a PDCCH communication.

Aspect 73: The method of any of Aspects 46-72, wherein the DL communication is configured with repetition in misaligned dynamic TDD symbols and aligned legacy TDD symbols and configured with different downlink TCI states.

Aspect 74: The method of Aspect 73, wherein the DL communication includes a PDSCH or a PDCCH communication.

Aspect 75: The method of any of Aspects 46-74, wherein the UL communication is configured without repetition in SBFD symbols and non-SBFD symbols and configured with different uplink TCI states or different uplink spatial relation information.

Aspect 76: The method of Aspect 75, wherein the UL communication includes at least one of a PUCCH communication or a PUSCH communication.

Aspect 77: The method of any of Aspects 46-76, wherein the UL communication is configured without repetition in misaligned dynamic TDD symbols and configured with different uplink TCI states or different uplink spatial relation information.

Aspect 78: The method of Aspect 77, wherein the UL communication includes at least one of a PUCCH communication or a PUSCH communication.

Aspect 79: The method of any of Aspects 46-78, wherein the UL communication is configured with repetition in SBFD symbols and non-SBFD symbols and configured with different uplink TCI states or with different uplink spatial relation information.

Aspect 80: The method of Aspect 79, wherein the UL communication includes at least one of a PUCCH communication or a PUSCH communication.

Aspect 81: The method of any of Aspects 46-80, wherein the UL communication is configured with repetition in misaligned dynamic TDD symbols and aligned legacy TDD symbols and configured with different uplink TCI states or with different uplink spatial relation information.

Aspect 82: The method of Aspect 81, wherein the UL communication includes at least one of a PUCCH communication or a PUSCH communication.

Aspect 83: The method of any of Aspects 46-82, wherein the UL communication includes a sounding reference signal communication in one or more of SBFD symbols, non-SBFD symbols, misaligned dynamic TDD symbols, or aligned legacy TDD symbols.

Aspect 84: The method of any of Aspects 46-83, wherein the DL communication includes a channel strength indicator reference signal communication in one or more of SBFD symbols, non-SBFD symbols, misaligned dynamic TDD symbols, or aligned legacy TDD symbols.

Aspect 85: The method of any of Aspects 46-84, wherein the communication includes a TBoMS across one or more of SBFD symbols, non-SBFD symbols, misaligned dynamic TDD symbols, or aligned legacy TDD symbols.

Aspect 86: The method of any of Aspects 46-85, wherein the DL communication includes a single DCI scheduled multi-PDSCH communication in one or more of SBFD symbols, non-SBFD symbols, misaligned dynamic TDD symbols, or aligned legacy TDD symbols.

Aspect 87: The method of any of Aspects 46-86, wherein the UL

communication includes a single scheduled multi-PUSCH communication in one or more of SBFD symbols, non-SBFD symbols, misaligned dynamic TDD symbols, or aligned legacy TDD symbols.

Aspect 88: The method of any of Aspects 46-87, further comprising receiving DCI indicating at least one of the communication parameters.

Aspect 89: The method of any of Aspects 46-88, further comprising receiving RRC signaling indicating at least one of the communication parameters.

Aspect 90: The method of any of Aspects 46-89, further comprising receiving MAC-CE signaling indicating at least one of the communication parameters.

Aspect 91: The method of any of Aspects 46-90, further comprising applying the communication parameter to the first slot or symbol based at least in part on the first slot or symbol being associated with SBFD symbols or misaligned dynamic TDD symbols.

Aspect 92: The method of any of Aspects 46-91, further comprising applying the communication parameter to the second slot or symbol based at least in part on the second slot or symbol being associated with non-SBFD symbols or legacy aligned TDD symbols.

Aspect 93: The method of any of Aspects 46-92, further comprising receiving an explicit indication associating the communication parameter of the first slot or symbol to communications during the first slot or symbol.

Aspect 94: The method of any of Aspects 46-93, further comprising receiving an explicit indication associating the communication parameter of the second slot or symbol to communications during the second slot or symbol.

Aspect 95: An apparatus for wireless communication at a device, comprising a processor; memory coupled with the processor; and instructions stored in the memory and executable by the processor to cause the apparatus to perform the method of one or more of Aspects 1-94.

Aspect 96: A device for wireless communication, comprising a memory and one or more processors coupled to the memory, the one or more processors configured to perform the method of one or more of Aspects 1-94.

Aspect 97: An apparatus for wireless communication, comprising at least one means for performing the method of one or more of Aspects 1-94.

Aspect 98: A non-transitory computer-readable medium storing code for wireless communication, the code comprising instructions executable by a processor to perform the method of one or more of Aspects 1-94.

Aspect 99: A non-transitory computer-readable medium storing a set of instructions for wireless communication, the set of instructions comprising one or more instructions that, when executed by one or more processors of a device, cause the device to perform the method of one or more of Aspects 1-94.

The foregoing disclosure provides illustration and description but is not intended to be exhaustive or to limit the aspects to the precise forms disclosed. Modifications and variations may be made in light of the above disclosure or may be acquired from practice of the aspects.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A network node (NN) for wireless communication, comprising:
one or more memories; and
one or more processors, coupled to the one or more memories, configured to cause the NN to:
perform a communication, of a downlink (DL) communication or an uplink (UL) communication, during a first slot or symbol; and
perform the communication during a second slot or symbol in addition to during the first slot or symbol,
wherein a communication parameter of the communication during the first slot or symbol is different from a communication parameter of the communication during the second slot or symbol based at least in part on the first slot or symbol and the second slot or symbol being associated with sub-band full duplex (SBFD) communication or dynamic time division duplex (TDD) communication.

2. The NN of claim 1, wherein the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

3. The NN of claim 1, wherein the first slot or symbol and the second slot or symbol are associated with dynamic TDD communication,
wherein the first slot or symbol includes misaligned cross dynamic time division duplex (TDD) symbols relative to communications by another network node and the second slot or symbol includes aligned legacy TDD symbols, and
wherein the communication during the first slot or symbol is one of the DL communication or the UL communication and the communication during the second slot or symbol is one of the DL communication or the UL communication.

4. The NN of claim 1, wherein the communication parameter includes a downlink transmission configuration indication (TCI) state, including a first downlink TCI state and a second downlink TCI state, and wherein the DL communication is configured with the first downlink TCI state for transmission during the first slot or symbol and the second downlink TCI state for transmission during the second slot or symbol.

5. The NN of claim 1, wherein the communication parameter includes a downlink transmission configuration indication (TCI) state in a unified TCI framework, including a first downlink TCI state and a second downlink TCI state in the unified TCI framework, and wherein the DL communication is configured with the first downlink TCI state for transmission during the first slot or symbol and the second downlink TCI state for transmission during the second slot or symbol.

6. The NN of claim 1, wherein the communication parameter includes uplink spatial relation information, including a first uplink spatial relation information and a second uplink spatial relation information, and wherein the UL communication is configured with the first uplink spatial relation information for transmission during the first slot or symbol and the second uplink spatial relation information for transmission during the second slot or symbol.

7. The NN of claim 1, wherein communication parameter includes a single TCI state and wherein at least one of the DL communication or the UL communication is configured with the single TCI state for communication during at least one of the first slot or symbol or the second slot or symbol.

8. The NN of claim 1, wherein the DL communication is configured without repetition in SBFD symbols and non-SBFD symbols and configured with different downlink transmission configuration indication (TCI) states.

9. The NN of claim 1, wherein the DL communication is configured with repetition in SBFD symbols and non-SBFD symbols and configured with different downlink transmission configuration indication (TCI) states.

10. The NN of claim 1, wherein the DL communication includes a channel strength indicator reference signal communication in one or more of SBFD symbols, non-SBFD symbols, misaligned dynamic TDD symbols, or aligned legacy TDD symbols.

11. The NN of claim 1, wherein the communication includes a transport block over multiple slots (TBoMS) across one or more of SBFD symbols, non-SBFD symbols, misaligned dynamic TDD symbols, or aligned legacy TDD symbols.

12. The NN of claim 1, wherein the DL communication includes a single DCI scheduled multi-PDSCH communication in one or more of SBFD symbols, non-SBFD symbols, misaligned dynamic TDD symbols, or aligned legacy TDD symbols.

13. A user equipment (UE) for wireless communication, comprising:
one or more memories; and
one or more processors, coupled to the one or more memories, configured to cause the UE to:
receive a downlink (DL) communication or transmitting an uplink (UL) communication, wherein the DL communication or the UL communication is during a first slot or symbol; and
perform a communication, of the DL communication or the UL communication, during a second slot or symbol in addition to during the first slot or symbol,
wherein a communication parameter of the communication during the first slot or symbol is different from a communication parameter of the communication during the second slot or symbol based at least in part on the first slot or symbol and the second slot or symbol being associated with network side sub-band full duplex (SBFD) communication or dynamic time division duplex (TDD) communication.

14. The UE of claim 13, wherein the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

15. The UE of claim 13, wherein the first slot or symbol and the second slot or symbol are associated with dynamic TDD communication,
wherein the first slot or symbol includes misaligned cross dynamic time division duplex (TDD) symbols relative to communications by another network node and the second slot or symbol includes aligned legacy TDD symbols, and
wherein the communication during the first slot or symbol is one of the DL communication or the UL communication and the communication during the second slot or symbol is one of the DL communication or the UL communication.

16. The UE of claim 13, wherein the UL communication is configured without repetition in SBFD symbols and non-SBFD symbols and configured with different uplink transmission configuration indication (TCI) states or different uplink spatial relation information.

17. The UE of claim 13, wherein the UL communication is configured without repetition in misaligned dynamic TDD symbols and configured with different uplink transmission configuration indication (TCI) states or different uplink spatial relation information.

18. The UE of claim 13, wherein the UL communication is configured with repetition in SBFD symbols and non-SBFD symbols and configured with different uplink transmission configuration indication (TCI) states or with different uplink spatial relation information.

19. The UE of claim 13, wherein the UL communication is configured with repetition in misaligned dynamic TDD symbols and aligned legacy TDD symbols and configured with different uplink transmission configuration indication (TCI) states or with different uplink spatial relation information.

20. The UE of claim 13, wherein the UL communication includes a sounding reference signal communication in one or more of SBFD symbols, non-SBFD symbols, misaligned dynamic TDD symbols, or aligned legacy TDD symbols.

21. The UE of claim 13, wherein the communication includes a transport block over multiple slots (TBoMS) across one or more of SBFD symbols, non-SBFD symbols, misaligned dynamic TDD symbols, or aligned legacy TDD symbols.

22. The UE of claim 13, wherein the UL communication includes a single scheduled multi-PUSCH communication in one or more of SBFD symbols, non-SBFD symbols, misaligned dynamic TDD symbols, or aligned legacy TDD symbols.

23. The UE of claim 13, wherein the one or more processors are further configured to cause the UE to apply the communication parameter to the first slot or symbol based at least in part on the first slot or symbol being associated with SBFD symbols or misaligned dynamic TDD symbols.

24. The UE of claim 13, wherein the one or more processors are further configured to cause the UE to apply the communication parameter to the second slot or symbol based at least in part on the second slot or symbol being associated with non-SBFD symbols or legacy aligned TDD symbols.

25. A method of wireless communication performed by a network node (NN), comprising:
performing a communication, of a downlink (DL) communication or an uplink (UL) communication, during a first slot or symbol; and
performing the communication during a second slot or symbol in addition to during the first slot or symbol,
wherein a communication parameter of the communication during the first slot or symbol is different from a communication parameter of the communication during the second slot or symbol based at least in part on the first slot or symbol and the second slot or symbol being associated with sub-band full duplex (SBFD) communication or dynamic time division duplex (TDD) communication.

26. The method of claim 25, wherein the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

27. The method of claim 25, wherein the first slot or symbol and the second slot or symbol are associated with dynamic TDD communication,
wherein the first slot or symbol includes misaligned cross dynamic time division duplex (TDD) symbols relative to communications by another network node and the second slot or symbol includes aligned legacy TDD symbols, and
wherein the communication during the first slot or symbol is one of the DL communication or the UL communication and the communication during the second slot or symbol is one of the DL communication or the UL communication.

28. A method of wireless communication performed by a user equipment (UE), comprising:
receiving a downlink (DL) communication or transmitting an uplink (UL) communication, wherein the DL communication or the UL communication is during a first slot or symbol; and
performing a communication, of the DL communication or the UL communication, during a second slot or symbol in addition to during the first slot or symbol,
wherein a communication parameter of the communication during the first slot or symbol is different from a communication parameter of the communication during the second slot or symbol based at least in part on the first slot or symbol and the second slot or symbol being associated with network side sub-band full duplex (SBFD) communication or dynamic time division duplex (TDD) communication.

29. The method of claim 28, wherein the first slot or symbol and the second slot or symbol are associated with SBFD communication and wherein the first slot or symbol has at least one SBFD slot or symbol and wherein the second slot or symbol has at least one non-SBFD slot or symbol, and wherein both the DL communication and UL communication are during the first slot or symbol.

30. The method of claim 28, wherein the first slot or symbol and the second slot or symbol are associated with dynamic TDD communication,
wherein the first slot or symbol includes misaligned cross dynamic time division duplex (TDD) symbols relative to communications by another network node and the second slot or symbol includes aligned legacy TDD symbols, and
wherein the communication during the first slot or symbol is one of the DL communication or the UL communication and the communication during the second slot or symbol is one of the DL communication or the UL communication.
